(19) United States
(12) Patent Application Publication
(10) Pub. No.: US 2007/0007771 A1
(43) Pub. Date: Jan. 11, 2007

(54) Energy recovery system

(75) Inventors: Richard James Biddle, Salibury (GB); Mym Biddle, Salisbury (GB); Miriam Suncock, Salisbury (GB); Jonathan Maguire, Marsden (GB)

Correspondence Address: SUGHRUE MION, PLLC, 2100 PENNSYLVANIA AVENUE, N.W., SUITE 800, WASHINGTON, DC, 20037, US

(73) Assignees: TTL DYNAMICS LTD., Salisbury Wiltshire (GB); FREEPOWER LTD, Salisbury Wiltshire (GB)

(21) Appl. No.: 10/569,228

(22) PCT Filed: Aug. 27, 2004
(86) PCT No.: PCT/EP04/09580

§ 371 Date: Aug. 30, 2006

(30) Foreign Application Priority Data
Aug. 27, 2003 (GB) 0320021.9
Aug. 27, 2003 (GB) 0320022.7
Aug. 27, 2003 (GB) 0320023.5
Aug. 27, 2003 (GB) 0320024.3
Aug. 27, 2003 (GB) 0320025.0
Aug. 27, 2003 (GB) 0320026.8

(51) Int. Cl. F02D 29/06

(52) U.S. Cl. 290/7

(57) ABSTRACT

An energy recovery system, for extracting energy from a source of waste heat (e.g., hot waste fluid from small industrial installations, automotive combustion engines, etc.) the system being a closed Rankine cycle system with a circulating working fluid. The system comprises: a first heat exchanger for receiving source fluid, incorporating the waste heat, at a first temperature and outputting said waste fluid at a second temperature, and for receiving said working fluid at a third temperature and outputting the working fluid at a fourth temperature, said fourth temperature being higher than said third temperature and higher than the boiling point of the working fluid; a turbine unit, ranged to receive the working fluid output from the first heat exchanger at a first pressure and to output the working fluid at a second pressure, said second pressure being lower than the first pressure, the turbine unit thereby imparting rotational energy to a turbine shaft mounted within the turbine unit; an electromechanical conversion unit (including an alternator), coupled to the turbine shaft, for converting said rotational energy into electrical energy, a cooling system, coupled to the turbine unit and to the first heat exchanger, for receiving the working fluid from the turbine unit at a fifth temperature, cooling the fluid, and supplying the fluid to the first heat exchanger at said third temperature. A technique for controlling the output power of the alternator is also disclosed Special turbine, bearing, torque coupling, power control and working fluid purification techniques are also disclosed.

The present invention relates to energy usage in diverse forms of industry, and more particularly relates to an energy recovery system.

There are many conventional techniques for generating (electrical) energy; most typically involve combustion of some fuel (e.g. coal, natural gas) that, ultimately, is in limited supply.

In addition, numerous energy conversion techniques have been described. For example, U.S. Pat. No. 4,896,509 discloses a process for converting thermal energy into mechanical energy in a Rankine cycle. Here, a cycle is repeated comprising the steps of vaporising a working fluid with a hot heat source (such as hot water from a boiler typically used to produce water-steam), expanding the resultant vapour in an expansion device (rotating or reciprocal displacement device, e.g. a turbine), cooling it with a cold heat source (such as cold water) to condense it (e.g. using condensers typically employed in the refrigerating apparatus), and compressing it using a pump. Such systems, however, typically employ combustion in the boiling.

Furthermore, a problem with available Rankine cycle systems are typically large scale plant operating in the multi megawatt range, and are not suited to extraction of energy on a smaller scale, from relatively low temperature sources, such as hot waste fluid from small industrial installations, automotive combustion engines, and the like.

There is a need for an energy recovery system that overcomes the aforementioned problems and provides an improved recovery system.

Energy Recovery

The present invention provides an energy recovery system, for extracting electrical energy from a source of heat, the system having a circulating working fluid, comprising: a first heat exchanger for receiving source fluid, incorporating at least part of the heat of the source of heat and for receiving said working fluid, whereby heat is transferred from the source fluid to the working fluid; an expansion unit, arranged to receive the working fluid output from the first heat exchanger whereby mechanical energy is imparted to the expansion unit; an electromechanical conversion unit, coupled to the expansion unit, for converting said mechanical energy into electrical energy, a cooling system, coupled to the expansion unit and to the first heat exchanger, for receiving the working fluid from the expansion unit, cooling the fluid, and supplying the fluid to the first heat exchanger. Preferably, the heat exchanger is a compact heat exchanger.

In one embodiment: the system is a closed system with a circulating working fluid, the first heat exchanger is adapted for receiving source fluid, incorporating the heat, at a first temperature and outputting said waste fluid at a second temperature, and for receiving said working fluid at a third temperature and outputting the working fluid at a fourth temperature, said fourth temperature being higher than said third temperature and higher than the boiling point of the working fluid; the expansion unit comprises a turbine unit, arranged to receive the working fluid output from the first heat exchanger at a first pressure and to output the working fluid at a second pressure, said second pressure being lower than the first pressure, the turbine unit thereby Imparting rotational energy to a turbine shaft mounted within the turbine unit; and the electromechanical conversion unit is coupled to the turbine shaft, for converting said rotational energy Into electrical energy. Preferably, the turbine is a high speed micro turbine.

Preferably, the cooling system includes a second heat exchanger, coupled to the turbine unit and to the first heat exchanger, for receiving a first supply of working fluid from the turbine unit at said fifth temperature and outputting working fluid from said first supply at a sixth temperature, said sixth temperature being lower than said fifth temperature; wherein the second heat exchanger is further adapted to receive a second supply of working fluid in liquid form at a seventh temperature and output working fluid from the second supply of fluid to said first heat exchanger at said third temperature. Preferably, the cooling system further includes a condensing unit, coupled to the second heat exchanger and adapted to receive a supply of cooling fluid, for receiving the working fluid output by the second heat exchanger at said sixth temperature and outputting working fluid in liquid form at said seventh temperature, said seventh temperature being lower than said sixth temperature and lower than the boiling point of the working fluid. Preferably, the cooling system includes a pump, coupled to the cooling unit, for receiving the liquid working fluid at said seventh temperature and pumping said liquid working fluid to said second heat exchanger, thereby providing said second supply of working fluid to the second heat exchanger.

In one embodiment, the first temperature is about 110 to about 225° C. In one embodiment, the second temperature is about 80 to about 140° C. In one embodiment, the first temperature is about 180° C. and said second temperature is about 123° C. In one embodiment, the first pressure is about 10 to 30 bar absolute. In one embodiment, the second pressure is about 0.5 to 2 bar absolute.

Preferably, the turbine shaft is mounted on a bearing within said turbine unit, and said working fluid permeates said turbine unit, thereby providing lubrication of said bearing.

Preferably, the working fluid comprises a single component fluid selected from the alkanes. Preferably, the working fluid comprises a fluid with a boiling point of about 30-110°.

Preferably, the electromechanical conversion unit includes an alternator adapted to output electric current. Preferably, the electromechanical conversion unit includes an electrical or electronic conditioning unit, coupled to said alternator, for altering the frequency of the current received from the alternator and outputting current at mains frequency. Preferably, the alternator is a high speed alternator.

In preferred embodiments, the expansion unit comprises a turbine unit having a shaft and at least one turbine stage mounted thereon, the or each turbine stage incorporating a set of vanes. The at least one turbine stage may be made of aluminium or steel. In certain embodiments, the at least one turbine stage is made of plastics material. The plastics material may be (a) polyetheretherketone (PEEK) containing carbon fibre, for example PEEK with 40% carbon fibre, (b) Ultem 2400, or (c) Valox 865.

In accordance with another aspect of the invention there is provided the use of HFE-7100 or hexane or water as the working fluid and/or lubrication fluid in the systems of any of the appended claims.

In accordance with another aspect of the invention there is provided the use of one of the alkanes as the working fluid and/or lubrication fluid in the systems of any of the appended claims.

In accordance with another aspect of the invention there is provided an electrical energy generation system, comprising: a microturbine system, the microturbine system comprising a combustion unit, coupled to a source of fuel, for combusting said fuel and outputting a first exhaust fluid, a turbine, coupled for receiving said first exhaust fluid whereby rotational energy is imparted, in use, to a turbine shaft of the turbine, the turbine being adapted to a output second exhaust fluid; an intermediate heat transfer unit, coupled for receiving said second exhaust fluid and adapted for performing a transfer of heat from the second exhaust fluid to an intermediate heat transfer fluid and to output the intermediate heat transfer fluid after said transfer of heat; and an energy recovery system according to any of claims 1 to 16, the energy conversion system having said first heat exchanger coupled for receiving said intermediate heat transfer fluid, the intermediate heat transfer fluid embodying said source of heat.

Preferably, the microturbine system further includes a compressor, coupled to the turbine and the combustion unit, and driven, in use, by the turbine shaft, the compressor receiving a supply of oxygen-containing fluid and supplying said oxygen-containing fluid in a compressed state, in use, to the combustion unit

Preferably, the microturbine system further includes a generator, coupled to the turbine and driven, in use, by the turbine shaft, the generator being adapted to output electrical energy.

The electrical energy generation system preferably further including a recuperator, disposed between the turbine and the intermediate heat transfer unit and coupled for receiving said second exhaust fluid and outputting third exhaust fluid to the intermediate heat transfer unit, the recuperator being further adapted for receiving a supply of oxygen-containing fluid, for example from the compressor, and for conveying said oxygen-containing fluid to the combustor after transfer of heat thereto from said second exhaust fluid.

Preferably, the recuperator comprises a heat exchanger.

In accordance with another aspect of the invention there is provided an electrical energy generation system, comprising: an internal combustion system, the internal combustion system comprising an internal combustion engine, coupled to a source of fuel, for combusting said fuel and outputting an engine exhaust fluid, the internal combustion engine being arranged whereby rotational energy is imparted, in use, to an drive shaft; an intermediate heat transfer unit, coupled for receiving said engine exhaust fluid and adapted for performing a transfer of heat from the engine exhaust fluid to an intermediate heat transfer fluid and to output the intermediate heat transfer fluid after said transfer of heat; and an energy recovery system according to any of claims 1 to 16, the energy conversion system having said first heat exchanger coupled for receiving said intermediate heat transfer fluid, the intermediate heat transfer fluid embodying said source of heat.

Preferably, the internal combustion system further includes a generator, coupled to the internal combustion engine and driven, in use, by the drive shaft, the generator being adapted to output electrical energy. Preferably, the internal combustion engine is coupled to a supply of fuel and to a supply of oxygen-containing fluid.

In accordance with another aspect of the invention there is provided an electrical energy generation system, comprising: a waste gas disposal stack, the waste gas disposal stack including a base stage, the base stage including a blower for blowing oxygen-containing gas Into the waste gas disposal stack, a combustion stage, adjacent the base stage, coupled to a source of waste gas, the waste gas being or including a combustible gas, the combustion stage being adapted to combust, in use, said waste gas in said oxygen-containing gas, a mixer stage, adjacent said combustion stage, adapted to generate a mixture of gases comprising air mixed with the combustor exhaust gases resulting from said combustion stage; an intermediate heat transfer unit, coupled for receiving said mixture of gases and adapted for performing a transfer of heat from the mixture of gases to an intermediate heat transfer fluid and to output the intermediate heat transfer fluid after said transfer of heat; and an energy recovery system according to any of claims 1 to 16, the energy conversion system having said first heat exchanger coupled for receiving said intermediate heat transfer fluid, the intermediate heat transfer fluid embodying said source of heat.

Preferably, the blower comprises an electrically powered blower, the blower is electrically coupled to the electromechanical conversion unit, and at least part of the electrical energy generated, in use, by the energy conversion system powers the blower.

Preferably, the intermediate heat transfer unit comprises a heat exchanger, and/or intermediate heat transfer fluid comprises heat transfer oil.

An advantage of the present Invention is that it provides an energy recovery system that is compact in scale. Another advantage is that it is capable of extracting energy from relatively low temperature sources. A further advantage is that it can recover energy at a reasonable efficiency from sources of heat that would otherwise be wasted, or from renewable sources, and/or it significantly enhances the amount of electrical energy generated in an energy generating system.

Turbine Design

A further problem is that, while single stage radial flow turbines are known, and two-stage axial flow turbines are known, heretofore there has been a lack of a two-stage radial flow turbine design capable of operating at the high-speed and extremely high pressure differentials encountered in some industries. Often, a problem is that it is not possible for a single stage radial turbine to cope with certain pressure drops.

Thus, in accordance with another aspect of the present invention, there is provided a radial inflow turbine unit, comprising: a housing with an inlet port for receiving fluid at a first pressure; a shaft mounted on a bearing within the housing and having an axis of rotation; a turbine, disposed on the shaft, the turbine comprising a first turbine stage, comprising a first series of vanes mounted on the shaft, said fluid received by the inlet port being radially incident on said first series of vanes and exiting the first turbine stage at a third pressure and in a first predetermined direction, a second turbine stage, comprising a second series of vanes mounted on the shaft, a conduit for conveying the fluid exiting the first turbine stage to the second turbine stage, said fluid received by the second turbine stage being radially incident on said second series of vanes and exiting the second turbine stage at a second pressure and in a second predetermined direction, wherein said fluid imparts rotational energy to said shaft at both said first and second turbine stages.

Preferably, the first pressure is about 2 to 10 times the second pressure. Preferably, the third pressure is about 3-4 times the second pressure.

Preferably, the radial dimension of said second turbine stage is greater than the radial dimension of the first turbine stage. Preferably, the radial dimension of second first turbine stage is about 1.25 times the radial dimension of the first turbine stage. Preferably, the axial dimension of said first turbine stage is about 0.3 to 0.375 times the radial dimension of the first turbine stage. Preferably, in the axial dimension of said second turbine stage is about 0.35 to 0.4 times the radial dimension of the second turbine stage.

In a particular embodiment, the turbine unit further includes: a third turbine stage, comprising a third series of vanes mounted on the shaft, a conduit for conveying the fluid exiting the second turbine stage to the third turbine stage, said fluid received by the third turbine stage being radially incident on said third series of vanes and exiting the third turbine stage at a fourth pressure and in a third predetermined direction, wherein said fluid imparts rotational energy to said shaft at said first, second and third turbine stages.

Preferably, the axial dimension of said third turbine stage is about 113 times the radial dimension of the third turbine stage.

Preferably, said first, second and/or third predetermined directions is generally axial.

In one embodiment, said fluid is a gas. Preferably, said fluid is HFE-7100 or hexane. The fluid may be one of the alkanes.

The invention further provides an energy recovery system, for extracting energy from a source of waste heat, the system being a closed system with a circulating working fluid, comprising a heat exchanger, an electromechanical conversion unit, a cooling system and a turbine unit according to any of the appended claims, the heat exchanger supplying, in use, the working fluid to said turbine.

Preferably, said fluid permeates the housing, thereby providing lubrication of the bearing.

An advantage of the invention is that it is usable at high rotational speeds (e.g. 25,000 to what 50,000 Rpm). An additional advantage is that the two-stage design entails a pressure drop occurring at each stage, allowing it to cope with higher input pressures (e.g. up to 20 bar absolute).

A further advantage is that a relatively compact design of the turbine is permitted.

The foregoing attributes ensure that the turbine may advantageously be employed in systems (e.g. Rankine cycle systems) where energy conversion occurs from fluids (gases) at very high operating pressures, with improved efficiency.

Bearing Design

A further problem arises in the lack of availability of bearing systems for compact scale rotating machinery. There is a need for such devices for supporting the shaft of a rotating component that is rotating at high speed. Moreover, a problem is that of providing a bearing system that operates as both a journal bearing and a thrust bearing in small-scale machinery. Bearings of this type must also be robust and reliable, so that they can be employed in systems operating 24 hours a day, seven days a week for extended periods (and have a life expectancy of the order of five years or more).

The present invention provides a bearing for supporting a shaft rotatable about an axis and at least partially disposed within a housing, comprising: a bearing member, fixedly attached to the housing and having a first bearing surface, opposite a second bearing surface on the shaft, said first and second bearing surfaces extending generally transverse to the axis, and a cylindrical internal channel defining a third bearing surface extending generally parallel to the axis and disposed opposite a fourth bearing surface on the shaft, the bearing member including conduits adapted to convey lubricating fluid into at least the space third and fourth bearing surfaces.

Preferably, the bearing member has, on the end thereof opposite the first bearing surface, a fifth bearing surface extending generally transverse to the axis.

Preferably, the bearing member has a generally T-shaped cross-section. Preferably, the first surface on the bearing element is defined by a raised annular surface on the top of the ‘T’ extending partially between the inner radial limit and the outer radial limit of the bearing member. Preferably, a plurality of elongate first recesses are provided extending radially in the first surface, thereby facilitating flow of lubricant fluid to the space opposite the first surface. Preferably, the first recesses extend partially between the inner radial limit and the outer radial limit of the first surface.

Preferably, a plurality of elongate second recesses are provided extending radially in the fifth surface, thereby facilitating flow of lubricant fluid to the space opposite the fourth surface. Preferably, the second recesses extend partially between the inner radial limit and the outer radial limit of the fifth surface.

Preferably, at a point between the opposite ends of the elongate part of the ‘T’-shaped bearing member, a circumferential recess is defined in the surface at the outer radial limit of the bearing member. Preferably, a plurality of first lubrication channels are provided, extending radially between the circumferential recess and the inner radial limit of the bearing member, thereby permitting flow of lubricant fluid between the exterior of the bearing member and the internal cylindrical channel.

Preferably, the bearing member includes a plurality of second lubrication channels, each channel extending axially between a first elongate recess on the first surface and a respective opposite second elongate recess on the fifth surface.

Preferably, the number of first and/or second elongate recesses is between 2 and 8, and preferably 6.

Preferably, the number of second lubrication channels is between 2 and 8.

The bearing preferably further includes a washer, wherein, in use, one surface of the washer abuts the fifth surface of the bearing member and the other surface of the washer is adapted to abut a corresponding surface of a drive element, for example a turbine.

The invention further provides an energy recovery system, for extracting energy from a source of waste heat, the system being a closed system with a circulating working fluid, comprising a heat exchanger, an electromechanical conversion unit, a cooling system and a turbine unit, the heat exchanger supplying, in use, the working fluid to said turbine unit as a gas, wherein the turbine unit is mechanically coupled to the electromechanical conversion unit via a shaft, the shaft being supported by a bearing according to any of the appended claims.

Preferably, the system further includes a secondary working fluid supply line from the cooling system to the bearing whereby working fluid is supplied to the exterior of the bearing member, thereby providing the lubricant fluid for said bearing. Preferably, the working fluid is supplied to the bearing as a liquid.

An advantage of the present invention is that it provides a bearing that is compact in scale. Another advantage is that it is capable of acting as both a journal bearing and a thrust bearing. In certain embodiments, and advantage is that lubrication Is provided by the working fluid, and no separate lubricant supply is needed.

Coupling

A further problem is that, while magnetic couplings are known, heretofore there has been a lack of a coupling design capable of operating at the high-speed and in a sealed unit that copes with the extremely high pressure differentials encountered in some industries. Often, a problem is that it is not possible to provide such a device with small dimensions.

Thus, in accordance with another aspect of the invention there is provided a rotary magnetic coupling, comprising: a first rotary member, including a first shaft having disposed thereon a first magnetic member, said first shaft, in use, being driven by a source of rotational energy, a second rotary member, including a second shaft having disposed thereon a second magnetic member, said second rotary member, in use, receiving rotational energy from the first rotary member through coupling of the first and second magnet members, wherein one of said first and second magnetic members, or both, comprise a plurality of magnet sections disposed at different angular positions with respect to the axis of said first and second shafts.

Preferably, the first rotary member is disposed within a hermetically sealed housing, a portion of the housing being disposed between the first rotary member and the second rotary member and being made of a non-magnetic material. Preferably, the non-magnetic material comprises stainless steel, nimonic alloy, or plastic.

In one embodiment, the first magnetic member comprises an inner generally cylindrical armature portion integral with the first shaft and a plurality of first magnet sections fixedly attached on the exterior of the armature portion; and the second magnetic member comprises an outer generally cylindrical supporting portion integral with the second shaft and a plurality of second magnetic sections fixedly attached to the interior of the supporting portion. Preferably, the first magnetic member further comprises a containment shell, disposed on the exterior of the first magnet sections, for retaining said first magnet sections in position during high-speed rotation of the first shaft. The containment shell may be made of a composite material, for example carbon fibre reinforced plastic (CFRF), Kevlar or glass fibre reinforced plastic (GRP). Preferably, the first magnetic member is disposed inside the second magnetic member and separated therefrom by the portion of the housing. Preferably, the magnet sections comprise dipole magnets the N-S direction of each extending radially.

In another embodiment, the first magnetic member is generally disc-shaped and comprises a first mounting section having fixedly mounted within it the plurality of first magnet sections, the first magnet sections thereby forming a disc shape; and the second magnetic member is generally disc-shaped and comprises a second mounting section having fixedly mounted within it the plurality of second magnet sections, the second magnet sections thereby forming a disc shape. Preferably, the first and second magnet sections form sectors of a disc. Preferably, the first and second magnet sections comprise dipole magnets with the N-S direction of each extending axially. Preferably, said first disc-shaped magnetic member is disposed axially aligned adjacent the second disc-shaped magnetic member and separated therefrom by the portion of the housing.

Preferably, the number of magnetic sections of said first magnetic member, and/or said second magnetic member, is an even number of 2 or more. More preferably, the number of magnetic sections of said first magnetic member, and/or said second magnetic member, is 4.

Preferably, the said magnet sections are made of ferrite material, samarium cobalt or neodymium iron boron.

The invention further provides a waste energy recovery system, for extracting energy from a source of waste heat, the system being a closed system with a circulating working fluid, comprising a heat exchanger, an electromechanical conversion unit, a cooling system and a turbine unit, the turbine being hermetically sealed and being coupled to the electromechanical conversion unit by a magnetic coupling according to any of the preceding claims.

An advantage of the invention is that it is usable at high rotational speeds (e.g. 25,000 to 50,000 Rpm). An additional advantage is that it provides a sealed unit preventing escape of the (sometimes harmful or hazardous) working fluid powering the turbine. A further advantage is that a relatively compact design of the turbine is permitted; and the mechanical isolation/magnetic coupling is particularly advantageous in enabling the turbine power to drive an off-the-shelf alternator, such as those found in automotive applications.

The foregoing attributes ensure that the magnetic coupling may advantageously be employed in systems (e.g. Rankine cycle systems) where energy conversion occurs from fluids (gases) at very high rotational speeds.

Power Control

Further drawbacks of available Rankine cycle systems are that they are typically large scale plant operating in the multi MW range, and are not suited to extraction of energy on a smaller scale, from relatively low temperature sources, such as hot waste fluid from small industrial installations, automotive combustion engines, and the like.

Moreover, in situations where electrical energy is being obtained from sources such as waste heat or solar thermal sources, it is desirable for the system being employed to extract the energy with the optimal efficiency.

Most existing Rankine cycle machines are low speed units with synchronous alternators, running at the same frequency as the grid supply. Turbine speed and power control is generally by valves to bypass the turbine. For example, U.S. Pat. No. 4,537,032 discloses a parallel-stage modular Rankine cycle turbine in which the load on the turbine is controlled by controlling the operation of each throttle valve. And US-A-2002/0108372 discloses a power generation system including two hot standby organic Rankine cycle turbine systems, in which one Rankine cycle turbine system includes a control valve for opening and closing in accordance with the output of the generator of the other Rankine cycle turbine system.

There is a need for an energy recovery system, and techniques for controlling them, that overcome the aforementioned problems and provides an improved recovery system.

Thus, in accordance with another aspect of the invention there is provided a method carried out in a an energy recovery system for extracting energy from a source of waste heat, the system being a closed system with a circulating working fluid, comprising a heat exchanger, an electromechanical conversion unit including an alternator, a cooling system, a turbine unit, and a control system coupled to the electromechanical conversion unit and adapted to vary the voltage derived from the alternator, comprising the steps of: (a) increasing the voltage by one voltage step; (b) measuring the output power of the alternator; (c) if the output power measured in step (b) is less than or equal to the previous output power, (i) decreasing the voltage by one voltage step, (ii) repeating the steps of (1) decreasing the voltage by one voltage step, (2) measuring the output power of the alternator, while the output power measured in step (c)(ii)(2) is more than the previously measured output power, and if the output power measured in step (b) is more than the previous output power, repeating the steps of (iii) increasing the voltage by one voltage step, (iv) measuring the output power of the alternator, while the output power measured in step (c)(iv) is more than the previously measured output power.

Alternatively, each step of increasing the voltage by one voltage step is replaced by the step of decreasing the voltage by one voltage step, and vice versa.

The amount of the voltage step may be about 1% to 2.5% of the mean voltage. Preferably, step (a) is performed about every second.

The step of measuring the output power of the alternator may comprise measuring an output voltage V derived from the output of the alternator, measuring the output current I derived from the output of the alternator, and computing output power=V*I. Alternatively, the step of measuring the output power of the alternator comprises measuring the output power with a separate power measuring device.

Preferably, the method further comprises converting the alternator voltage from a first frequency to a second frequency. Preferably, the first frequency is higher than the second frequency, and the second frequency is about the frequency of the mains supply. Preferably, said step of converting the voltage comprises: rectifying the voltage output by the alternator using a rectification circuit thereby deriving a dc voltage, and generating an ac voltage from said dc voltage using a power conditioning unit.

The method preferably further comprises storing the last-measured value of the output power.

The invention further provides a programmable control system when suitably programmed for carrying out the method of any of the appended claims, the system including a processor, a memory, an interface coupled to the electromechanical conversion unit, and a user interface.

An advantage of the present invention is that it makes possible systems and techniques that maximise efficiency and are applicable in compact, high-speed systems, and in particular in low-power units.

Working Fluid Purification

In many conventional energy conversions systems operating as closed systems and employing an expansion device such as a turbine, e.g. Rankine cycle systems, a working fluid is employed, which passes through various stages in the system and is normally in liquid form at some point.

Typically, when the system is initially filled, the working fluid is a liquid, and there is therefore the rest of the system that must be filled with a gas, such as nitrogen.

A problem with such systems is that, if there are non-condensable gases present during the running of the system, the overall performance can be substantially reduced. This is because, for example with a turbine-based system, the pressure that the turbine gas expands to on exit must be as low as possible, in order to make the turbine pressure ratio (pressure at input:pressure at exit) as high as possible.

Techniques for attempting to deal with this problem have been disclosed in U.S. Pat. Nos. 5,119,635 and 5,487,765. However, these impose the additional requirement of a separate apparatus for pumping gases out of the condenser, cooling them to condense the working fluid and leave undesirable non-condensable gases, and then pumping the liquid working fluid back into the system.

The present invention seeks to provide a much simpler and easily implemented system for removing impurities from a working fluid.

Thus, in accordance with another aspect of the invention there is provided a working fluid purification system for an energy conversion system, the energy conversion system being a closed system with a circulating working fluid circulating in a path therethrough and including an expansion device, for example a turbine, comprising: an expansion tank; a diaphragm within the expansion tank, thereby defining a variable volume connected for receiving said working fluid; and a control valve disposed between said path and the expansion tank, the control valve being adapted to control the flow of fluid to and/or from said variable volume; wherein the control valve is connected via a conduit to a connection point in the path, said connection point being at the highest point of said path.

Preferably, the control valve is mounted at a higher point than said connection point. Preferably, the expansion tank is mounted at a higher point than said control valve.

The system preferably further includes a controller, the controller being adapted to open and close said control valve. Preferably, the controller is configured to perform a purification cycle, said purification cycle comprising opening the control valve for a first predetermined period and closing the control valve for a second predetermined period. Preferably, the controller is configured to perform, in a start-up sequence of predetermined duration after switch-on of the system, a plurality of said purification cycles. Preferably, the plurality of purification cycles comprises about 3 to 5 purification cycles. Preferably, the first predetermined period is about 1 minute and said second predetermined period is about ten minutes.

The system preferably further includes a pressure sensor coupled to the controller; wherein the controller is configured to perform at least one purification cycle when the pressure indicated by the sensor is above a predetermined level. Preferably the pressure sensor is arranged to sense the pressure at the exit of a turbine (expansion device).

In another aspect of the invention there is provided an energy recovery system for extracting electrical energy from a source of heat, comprising: the working fluid purification system of any of the appended claims, a turbine, a heat exchanger, an electromechanical conversion unit, and a cooling system, the heat exchanger supplying, in use, the working fluid to said turbine.

The present invention will now be described, by way of example, with reference to the accompanying drawings in which:

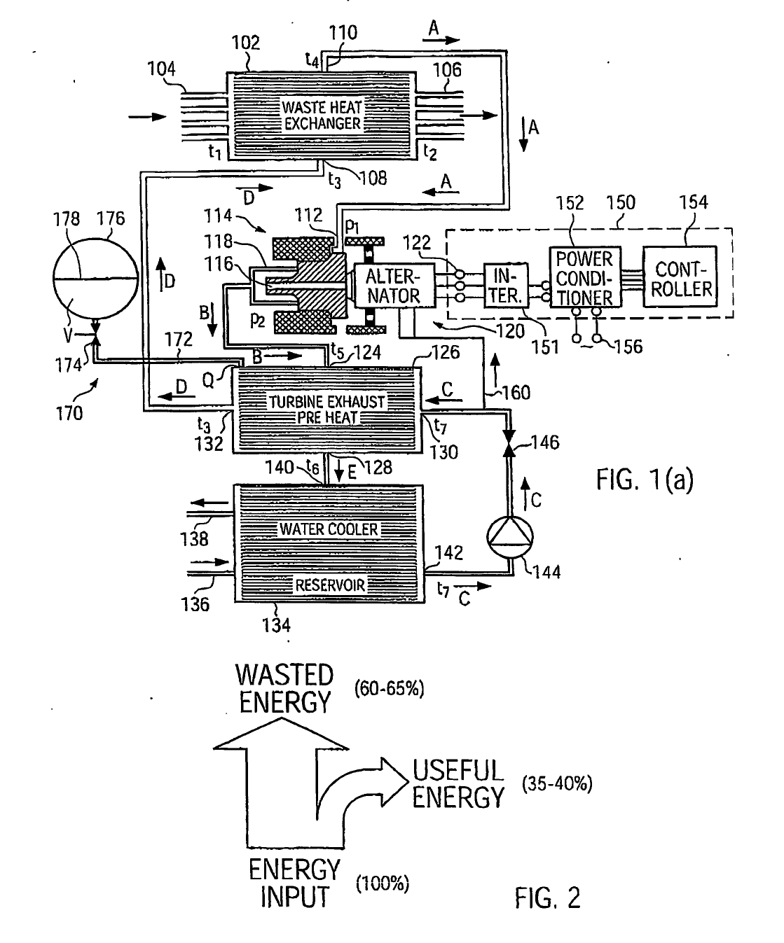

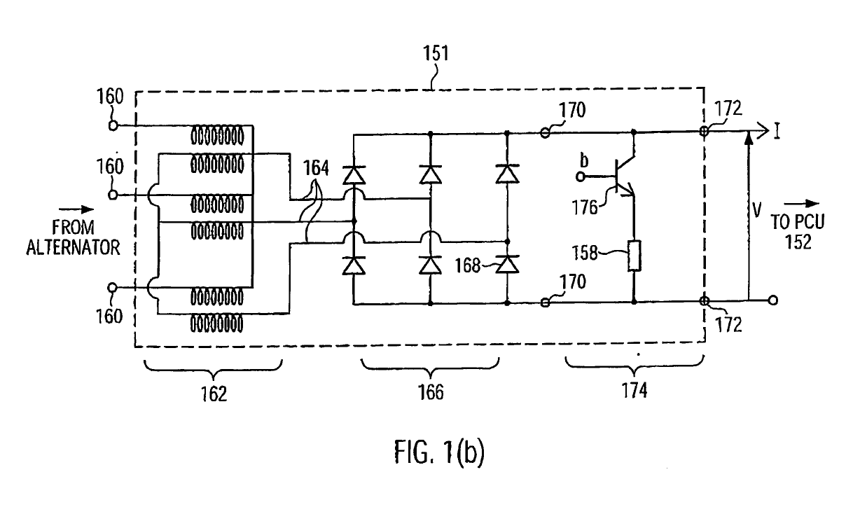

FIG. 1 is shows (a) schematic overview of an energy recovery system in accordance with one aspect of the invention, and (b) intermediate electronics modifying the output of the alternator;

FIG. 2 is a schematic illustration of the derivation of one source of waste heat in one aspect of the invention;

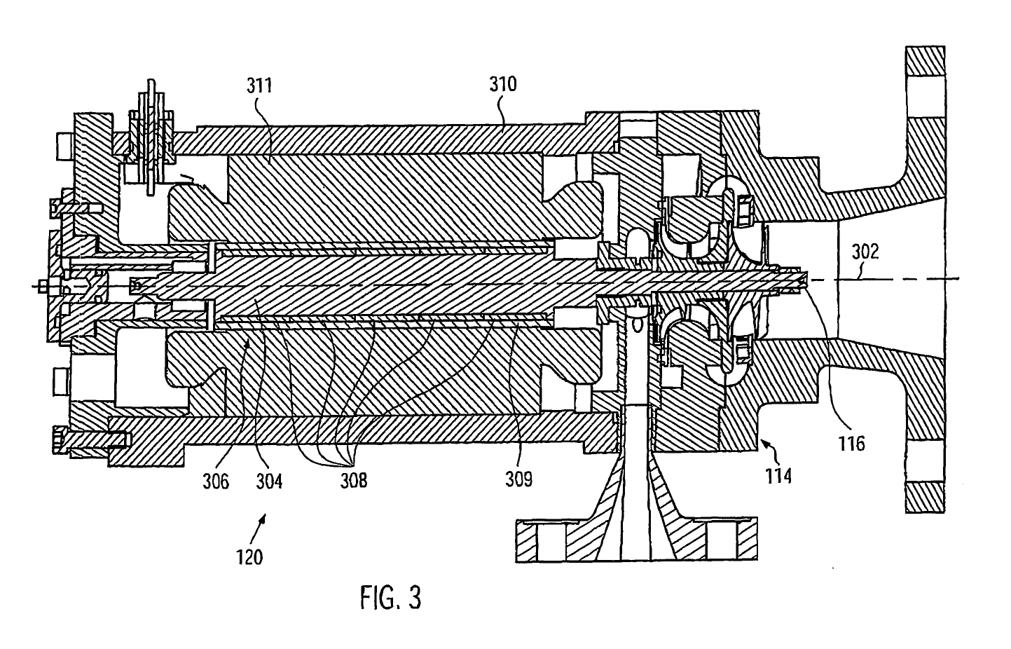

FIG. 3 illustrates In more detail the turbine unit and alternator of FIG. 1;

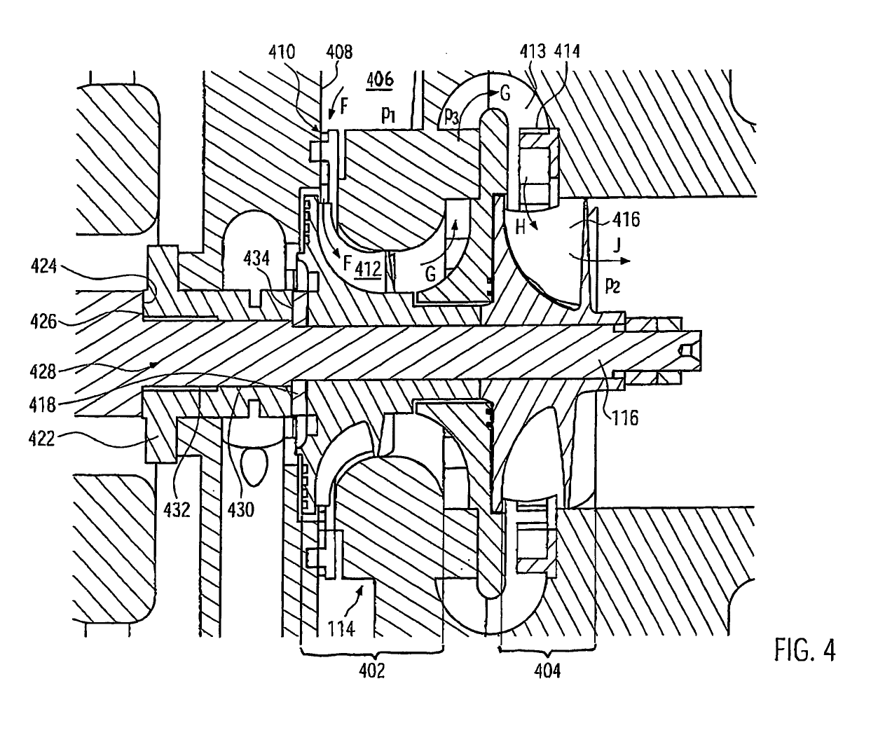

FIG. 4 is an enlarged view of the turbine bearing in FIG. 3;

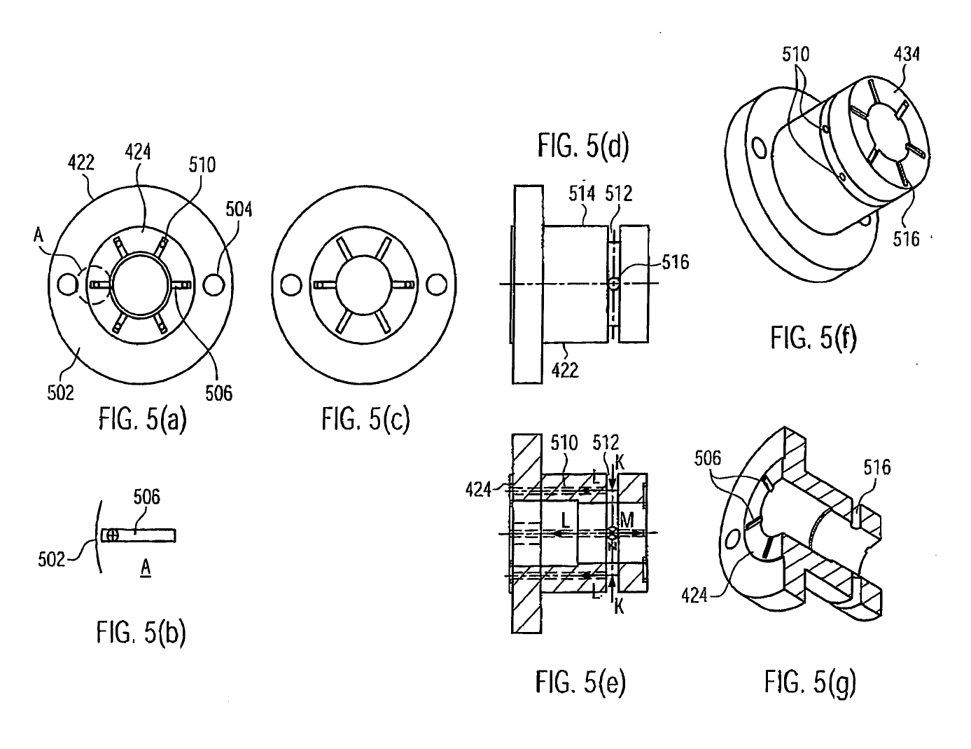

FIG. 5 shows in more detail the bearing member employed in the bearing in FIG. 4, indicating fluid flows;

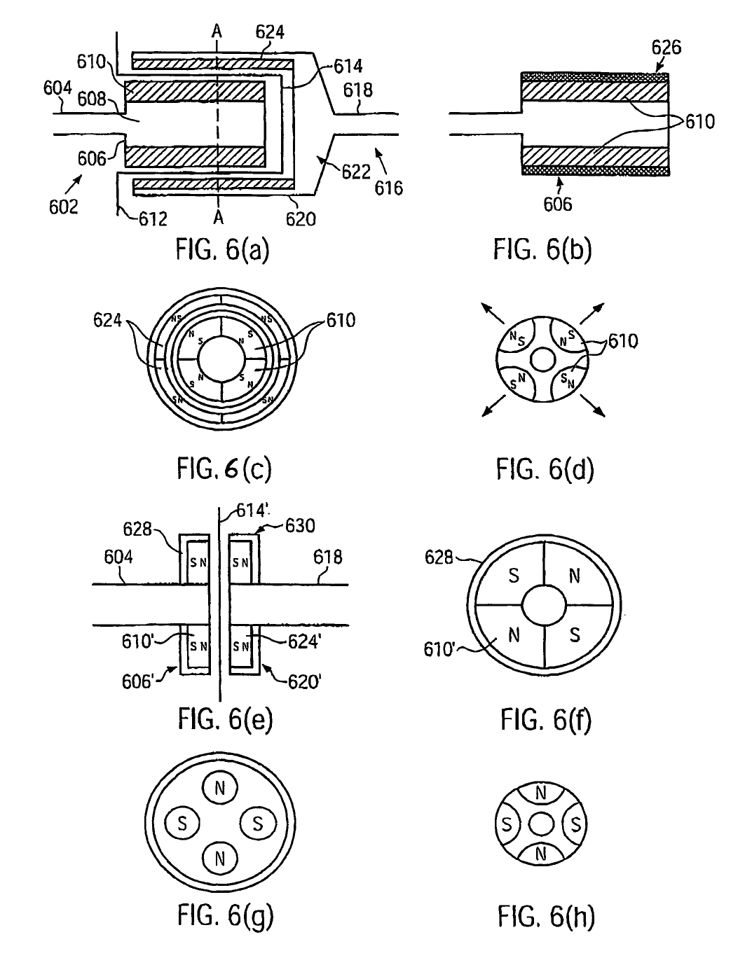

FIG. 6 illustrates an alternative (magnetic) coupling of the turbine unit and alternator of FIG. 1, in another aspect of the invention;

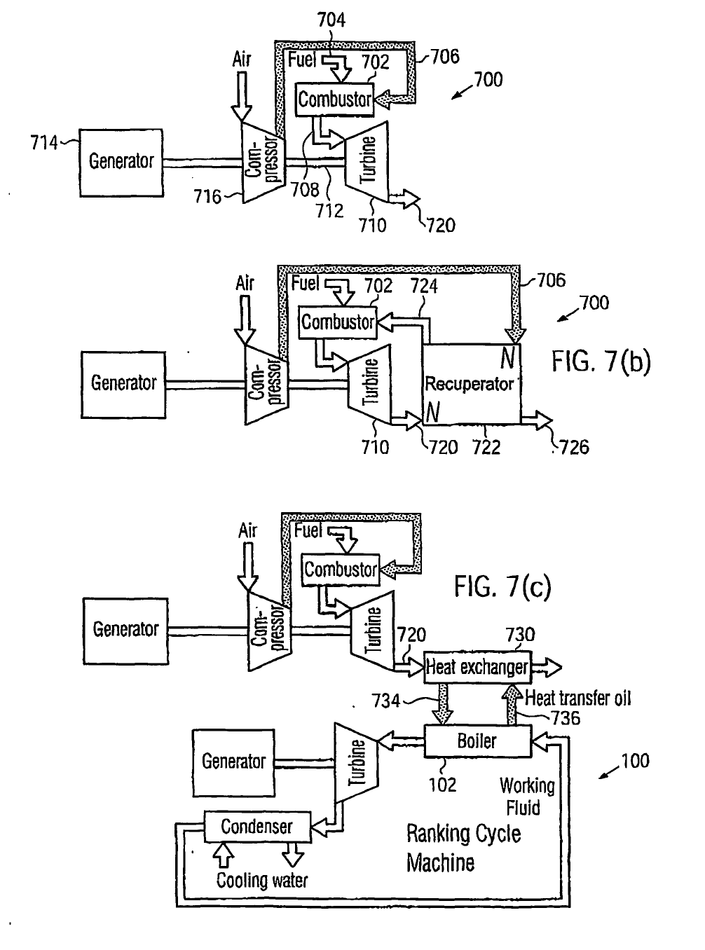

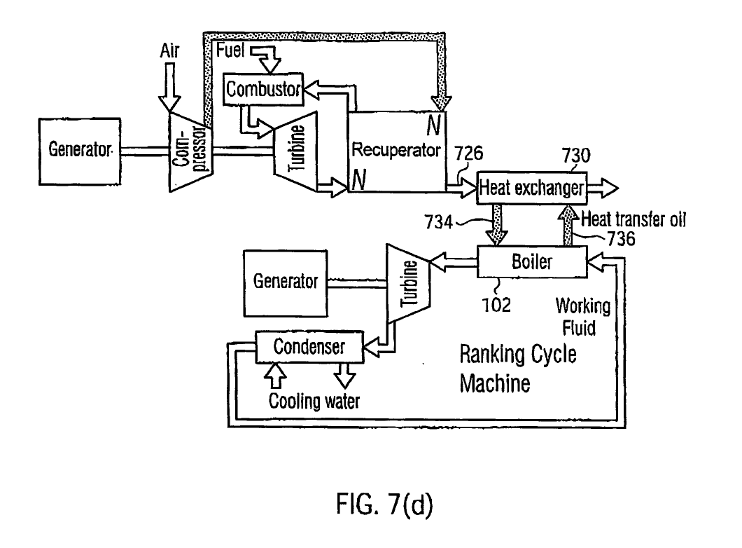

FIG. 7 provides various view of a microturbine-based system (a) in isolation, (b) with a recuperator, and (c) and (d) the same systems as (a) and (b), respectively, incorporating, in accordance with aspects on the invention, an energy recovery system;

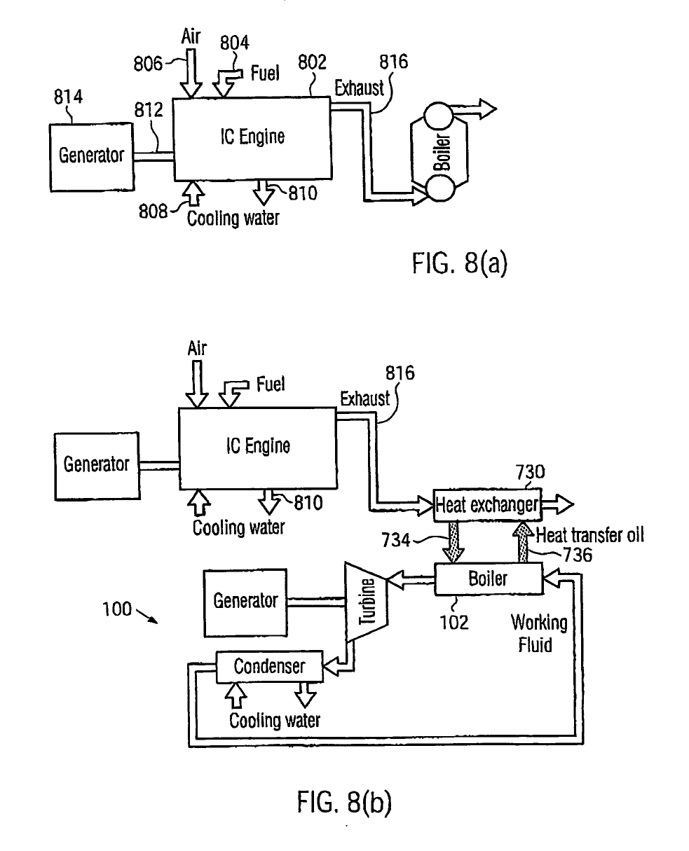

FIG. 8 shows (a) an IC engine based energy generation system, and (b) the same system incorporating, in accordance with another aspect of the invention, an energy recovery system; and

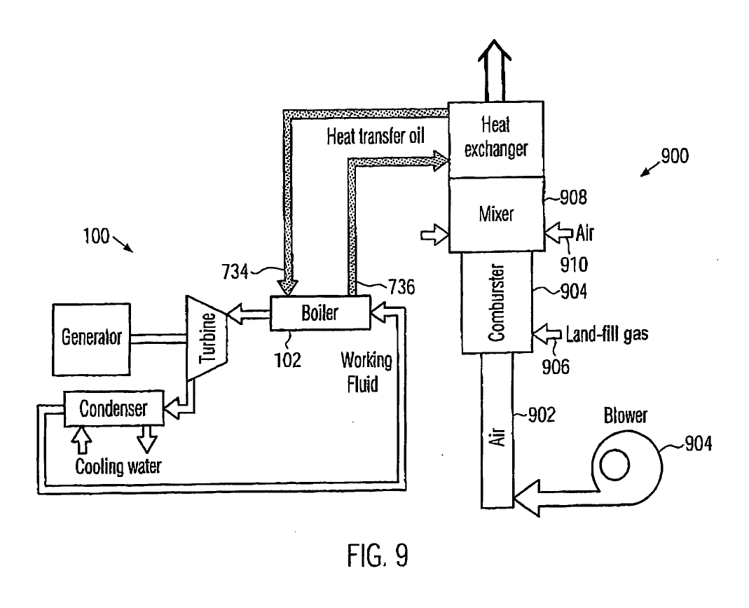

FIG. 9 shows an flare stack based energy generation system incorporating, in accordance with another aspect of the Invention, an energy recovery system.

Turning to the drawings, in which like numerals have been used to designate like elements, FIG. 1(a) is a schematic overview of an energy recovery system 100 in accordance with one aspect of the invention. References herein to “energy recovery system” include reference to energy recovery systems that recover energy (e.g. electrical) from sources of energy (e.g. heat) that would otherwise be wasted, and energy conversion systems that convert energy from one form (e.g. heat) to another (e.g. electrical) In circumstances where the original (heat) energy would not have necessarily been wasted but may have been used in its existing form (e.g. to at least contribute to heating a building).

A main heat exchanger 102 has at least one source fluid inlet 104 through which it receives a heated source fluid incorporating the thermal energy that is sought to be recovered by the system. The temperature of the source fluid upon entering the main heat exchanger 102 is designated t1.

The main heat exchanger 102 may be driven by any source of heat, and examples of the sources include hot air, steam, hot oil, exhaust gases from engines, manufacturing process waste hot fluid, exhaust fluids from microturbine-based electricity generation systems, IC engine-based electricity generation systems, flare stacks burning waste gases, etc. Alternatively, the heat source may be solar thermal energy that heats a suitable fluid (e.g. heat transfer oil) that forms the source fluid for the main heat exchanger 102.

Referring briefly to FIG. 2, this is a schematic illustration of the derivation of one source of waste in one aspect of the invention: an important example of wasted energy is the ubiquitous internal combustion engine, be it petrol, diesel or gas fuelled, reciprocating or turbine. The best simple cycle fossil fuelled engine (other than very large power stations or marine engines) will be between 3540% efficient: this means that 60-65% of the energy from the fuel used to drive the engine is lost as waste heat.

Returning to FIG. 1(a), the source fluid exits the main heat exchanger 102, at a reduced temperature t2, via at least one source fluid outlet 106.

The main heat exchanger 102, which is suitably of the cross counter flow type, also has a working fluid inlet 108 and working fluid outlet 110, through which it receives (as a liquid at temperature t3) and despatches (at temperature t4), respectively, the working fluid of the system. The working fluid, which is heated and vapourised within the main heat exchanger 102, is carefully chosen so that its thermodynamic and chemical properties are suitable to the system design and the operational temperatures and pressures. In one embodiment, the working fluid is HFE-7100.

After exit from the working fluid outlet 110 of the main heat exchanger 102, the gaseous working fluid flows in the direction of arrows A to the turbine inlet 112 of turbine unit 114. The working fluid arrives at the turbine unit 114 at pressure p1, loses heat and pressure in driving the turbine (not shown) mounted on turbine shaft 116 within the turbine unit 114, and exits the turbine unit 114 via turbine outlets 118 at pressure p2, which is substantially lower than p1. In one embodiment, the pressure p1 is 11.5 bar absolute and the pressure p2 is 1.0 bar absolute.

In one embodiment, the turbine shaft 116 is mounted on a bearing (not shown) and is mechanically coupled to an alternator 120, e.g. the turbine and alternator armature (not shown) are mounted on a common shaft 116. In this way, high-speed rotation of the turbine shaft 116 causes electrical energy to be generated in the alternator 120, the consequent voltage appearing at the alternator output 122. The coupling of the turbine shaft 116 to the alternator 120 is described further hereinbelow with reference to FIGS. 3 to 5.

After exit from the turbine outlets 118, the working fluid travels in the direction of arrows B to inlet 124 of a second heat exchanger 126, which acts as a preheater of the working fluid using the turbine exhaust. The working fluid is therefore input to the second heat exchanger 126 at temperature t5 and exits via outlet 128 at a lower temperature t6. At the same time, the second heat exchanger receives another flow of working fluid (in the direction of arrows C), below its boiling point and in liquid form, via inlet 130 at temperature t7. In the second heat exchanger 126, thermal energy Is transferred to the flow of working fluid arriving at inlet 130, the working fluid exits via outlet 132 at temperature t3, and flows (in the direction of arrows D) to the inlet 108 of the main heat exchanger 102.

The system also includes a condensing unit (or water cooler) 134, in which cold water arrives via inlet 136 and exits via outlet 138. In operation, working fluid from the second heat exchanger 126, flowing in the direction of arrow E, arrives in the condensing unit 134 via inlet 140, is cooled and condensed into a liquid in the condensing unit 134, and then departs via outlet 142. This liquid working fluid (at temperature t7), is forced by pump 144 via valve 146 in the direction of arrows C and forms the second supply of working fluid arriving at second heat exchanger 126, to begin the cycle all over again. In one embodiment, a separate fluid line 160 delivers liquid working fluid to the bearing coupling the turbine unit 114 and the alternator 120, for lubrication.

Thus, the system operates on a Rankine cycle and is sealed, so that there is no escape or consumption of the working fluid, which simply cycles through its various phases.

In one embodiment, the system includes a control system 150, to control the power output by the system. Most existing Rankine cycle machines are low speed units with synchronous alternators, running at the same frequency as the grid supply. Turbine speed and power control is generally by valves to bypass the turbine. However, the system according to one aspect of the present invention employs a high-speed alternator 120, and a power-conditioning unit is preferably used to convert the high frequency alternator output to mains frequency.

More specifically, the control system includes intermediate electronics 151, a power conditioning unit (PCU) 152 and a controller 154. The power output by the alternator 120 at outputs 122 is at a very high frequency, due to the high-speed rotation of the turbine shaft, and is modified by intermediate electronics 151, which is described in more detail in FIG. 1(b).

Referring to FIG. 1(b), the outputs 122 of the alternator 120 are connected to the inputs 160 (three of them, for a 3-phase alternator) of intermediate electronics, generally designated 151. The first stage of intermediate electronics 151 is an optional transformer stage 162, for boosting the voltage on each of the lines: this ensures, when needed, that there is sufficient dc voltage eventually appearing at the PCU 152 that a complete 240 V sine wave (as per UK mains supply) can be generated at the output of the PCU 152. In certain embodiments, however, the voltage level output by the alternator 120 is high enough such that the transformer stage 162 can be omitted.

Next, the voltages output by the transformer stage 162 at 164 pass to a rectification stage 166, comprising a set of six rectification diodes 168, as is well known in the art. Thus, a rectified, near dc voltage is supplied at outputs 170 of the rectification stage 166, and this, in normal operating conditions appears at the outputs 172 of the intermediate electronics 151.

In the event of a sudden loss of grid connection all alternator load will be lost. This could cause a significant overspeed of the alternator 120, and so as well as a dump valve (not shown) to bypass the turbine, the intermediate electronics 151 includes a safety stage 174 that includes a dump resistor 158 to supply a load to the alternator 120 in the event of loss of grid connection, to prevent overspeed.

A transistor 176 is in series with the dump resistor 158 across the outputs 172, with the base b of the transistor 176 being driven by an overspeed detection unit (not shown). The latter supplies a PWM signal to the transistor 176, the duty cycle of which is proportional to the extent of overspeed, so that the higher the overspeed the greater the load applied by the dump resistor 158.

As can be seen in FIG. 1(b), the power supplied at outputs 172 (referred to herein as dc bus) is at voltage V and current I, and this is supplied to the PCU 152. The PCU 152, which is known in the art, is adapted to convert power from do to ac at the mains frequency (50 Hz in UK) and voltage (240 V in UK). The PCU in turn is able to vary the dc bus voltage so as to adjust the power output of the system. Varying the dc bus voltage (V in FIG. 1(b)) in the power conditioning unit 152 controls the speed of the turbine shaft 116. Reducing the bus voltage increases the load on the alternator 120, causing more current to be drawn from the alternator. Conversely, increasing the bus voltage causes the alternator current to drop. By calculating the power (e.g. using P=VI, or using a power measuring device) before and after the bus voltage change, it can be determined whether the power was increased or decreased by the bus voltage change. This allows the point of maximum power output from the alternator 120 to be found and then continually ‘tracked’ by altering the bus voltage.

In one embodiment, the voltage supplied by the alternator at no load is 290 Vac (all voltages are measured line-to-line) on each of the three phases at 45,000 rpm, the maximum rated speed of the alternator 120. The lowest speed at which power can be generated is 28,000 rpm, at which point the voltage is 180 Vac at no load. Increasing the load will also reduce the alternator voltage: for example at 45,000 rpm the voltage will be 210 Vac at 6.3 kW.

The control of power output by varying the bus voltage may be implemented by suitable analog or digital electronics, microcontroller, or the like. It may also be controlled manually using a personal computer (PC) as the controller 154. Preferably, however, the power output is controlled automatically using a suitably programmed PC or other computing machinery as the controller 154. In either case, the PC communicates with the PCU 152 by means of a RS232 serial communications device, although a RS422 or RS485 adapter could also be used, as is known in the art. The PC may thus, at any time, have a reading of V and I, thereby enabling the instantaneous power to be known.

In the case of automatic PC control, the method of control may be by means of suitable software implementing the following.

While system is ON do

Increase bus voltage by one voltage step

Measure new power (=VI)

if new power less than or equal to old power then decrease voltage by one voltage step
do
decrease voltage by one voltage step
measure new power
while new power more than old power

else do
increase voltage by one voltage step
measure new power
while new power more than old power.

It will be appreciated by persons skilled in the art that the size of the voltage step is determined by operating conditions and is a suitably determined small fraction (e.g. 1-2.5%) of the mean bus voltage. In one embodiment, the voltage step change is made about every second.

One other optional feature incorporated in the system is a working fluid purification system, generally designated 170 in FIG. 1. As mentioned hereinabove, if there are non-condensable gases present during the running of the system, overall performance can be substantially reduced, i.e. the pressure ratio of the turbine is lower than it should be. For example, in the turbine mentioned in the examples herein, the input pressure p1 is projected to be 20 bar; and if the output pressure p2 is 2 bar rather than the intended 1 bar, the pressure ratio is 10 rather than 20, giving significantly reduced performance.

A difficulty is that when filling the system initially, the working fluid is a liquid and the rest of the system must be filled with a gas, for example nitrogen. When performing this step the pressure can be reduced to below atmospheric pressure to reduce the mass of nitrogen in the system. However, the pressure cannot be reduced too much, or cavitation will occur In the pump. Therefore, the optimum way to remove the unwanted gas from the system is during the running of the system.

The working fluid purification system 170 includes a conduit 172 connected at one end to a point Q on the second heat exchanger (preheater) 126 and at the other end to control valve 174 which may be at the base entry/exit port 176 of an expansion tank 176, which, in one example, may be the type of expansion tank used in central heating systems. The expansion tank 176 has a flexible membrane or diaphragm 178 so that it may in its lower part contain a variable volume V of gas and/or liquid.

In the example (6 kW system) mentioned hereinafter, the measurements are as follows.

| | |
|---|---|
| System volume | 70 litres |
| Fluid volume | 18 litres |
| Expansion tank volume | 50 litres |

As can be seen, when the system is initially filled with fluid, there will be 52 litres of nitrogen. Lowering the pressure of this gas with a vacuum pump reduces the amount of gas that has to be held in the expansion tank 176, meaning that it can be made smaller. This pumping also causes the diaphragm 178 expand downwards into the expansion tank, making the whole of the tank, or nearly all of it, available for receiving gases.

As nitrogen gas has a lower density than that of the working fluid vapour, it tends to accumulate at the highest location within the system. At this point (Q in FIG. 1), the fluid can be taken away to the expansion tank 176, the diaphragm 178 allowing expansion to take place, enlarging volume V; i.e., with the control valve 174 open, the gases are allowed to move slowly into the expansion tank 176. As the nitrogen has a lower density than the working fluid, most of the contents of the expansion tank 176 will be nitrogen, with just a little working fluid.

Once the valve 174 has closed, the expansion tank 176 and its contents cool down naturally, causing the working fluid to condense. The next time the control valve 174 is opened, the (now liquid) working fluid flows back under gravity back into the main circuit of the system (via control valve 174 and conduit 172)), while the non-condensable gases tend to stay in the expansion tank 176 due to their lower density. A cycle of (a) control valve OPEN for a fixed period, followed by (b) control valve CLOSED for a fixed period is used to purify the working fluid, and this cycle may be repeated several times (for example about 3 to 5 times), during the start up of the energy recovery system, to collect as much nitrogen in the expansion tank 176 as possible. In the aforementioned (6 kW) system, the control valve 174 is opened for one minute and then closed for ten minutes. The opening and closing of the control valve 174 may be performed manually, or It may be performed automatically by a suitable controller, in this case controller 154.

The system preferably also Includes a pressure sensor coupled to the controller 154, the pressure sensor being positioned to sense the pressure at the exit of the expansion device (turbine); and the purification cycle may be repeated if pressure starts to build up during normal running of the system and it is detected at the pressure sensor that the pressure has exceeded a predetermined safe threshold.

FIG. 3 illustrates in more detail the coupling of the turbine unit and alternator of FIG. 1(a). Here, the turbine unit is generally designated 114 and the alternator generally designated 120. The turbine shaft rotates about an axis 302 and is integral with a section 304 that forms part of the rotor 306 of the alternator 120. Generally partial cylinder permanents magnets 308 are disposed on the section 304 of the shaft 116. Retaining the magnets 308 in position on the shaft 116 is a retaining cylinder 309: this retaining cylinder (made of a non-magnetic material such as CFRP) ensures that the magnets 308 are not dislodged during high-speed rotation of the shaft 116. The stator 311, incorporating a plurality of windings (not shown) in which current is generated, is mounted around the rotor 306, as is well known in the art, and is enclosed within housing 310. The section 304 of the shaft 116 is supported at one end of the housing 310 by journal bearing 312, and at the other end by the bearing generally designated 314, which is described in more detail hereinafter.

FIG. 4 is an enlarged view of the turbine-bearing coupling in FIG. 3. As can be seen, the turbine unit 114 includes a first turbine stage 402 and a second turbine stage 404. High pressure heated working fluid present (at pressure p1) in the space 406 within the turbine unit housing 408 enters via inlet port 410 of the first turbine stage 402 and flows in the direction of arrow F so as to be incident upon a first series of vanes 412 securely mounted on the shaft 116. The fast flowing working fluid thereby imparts rotational energy to the shaft 116. Upon exiting the first turbine stage 402 (at pressure p3), the working fluid flows in the direction of arrows G.

Next, the working fluid at (intermediate) pressure p3 (which is substantially less than p1, but still relatively high) passes, via conduit 413, to the next turbine stage 404. Here, the working fluid enters via Inlet port 414 of the second turbine stage 404 and flows In the direction of arrow H so as to be Incident upon a second series of vanes 416 securely mounted on the shaft 116. The fast flowing working fluid thereby imparts further rotational energy to the shaft 116. Upon exiting the second turbine stage 404 (at pressure p2), the working fluid flows in the direction of arrow J. Thus, p1>p3>p2.

As can be seen, the axial and radial dimensions of the vanes 416 of the second turbine stage 404 are greater than those of the vanes 412 of the first turbine stage 402. In one embodiment, there are two turbine stages of equal diameter, and the axial dimension of the first turbine stage is 3/10 of the diameter, and the axial dimension of the second turbine stage is 4/10 the diameter. In another embodiment, there are three turbine stages. The diameters of the first, second and third turbine stages are in the ratio 4:5:6. The axial dimension of the first turbine stage is 0.375× the respective diameter. The axial dimension of the second turbine stage is 0.35× the respective diameter. The axial dimension of the first turbine stage is 0.33× the respective diameter.

The choice of material from which the turbine stages are manufactured is important. In one embodiment of the system, aluminium (Al 354; a high-strength casting alloy) is used; and in a larger (120 kW) system, stainless steel (E3N) is used.

The main requirement for the material is to have a high ratio of ultimate tensile strength (UTS) to density. When spinning at high speed, the higher the material density, the higher the stresses in the turbine, and so more dense materials are also required to have a proportionally higher strength.

In accordance with one embodiment, the turbine stages (also referred to as turbine wheels) incorporating the vanes are made of engineering plastics, such as polyetheretherketone (PEEK) filled with 40% carbon fibre. Such materials have the advantage of very low cost as the turbine wheels can be produced by injection moulding. The plastic turbine wheels are mounted, using a suitable fixing technique, on, for example, a steel shaft. The properties of various turbine materials are set out in Table 1.

TABLE 1

| | Ultimate tensile strength | Density | |
|---|---|---|---|
| Material | (UTS) (Mpa) | (kg/cu.m) | UTS/density |
| Al 354 | 331 | 2710 | 0.122140221 |
| SS E3N | 760 | 7800 | 0.097435897 |
| PEEK 40% CF | 241 | 1460 | 0.165068493 |
| Ultem 2400 | 248 | 1608 | 0.154228856 |
| Valox 865 | 179 | 1634 | 0.109547124 |

As can be seen from Table 1, the best material (highest UTS/density ratio) is PEEK 40% CF. Two other high performance plastics (Ultem 2400 and Valox 865) are also included in Table 1 to illustrate the breadth of plastics available and suitable for use in the manufacture of the turbine stages. A consideration in the use of plastics (last three rows in Table 1) is the effect on operating temperature (turbine inlet temperature) that can be employed. Whereas in systems with aluminium turbines this temperature can be up to 200° C., and can be even higher with stainless steel turbines, systems with, for example, PEEK 40% CF turbines can only be used up to 150° C. In the latter case, the cycle of the overall system 100 is designed to take account of this operating temperature.

Returning to FIG. 4, a washer 418 is provided fixedly attached to a shoulder 420 of the turbine stage 404 and has its other surface abutting a bearing member 422, which is described in more detail hereinafter, and in operation, the working fluid permeates the space between the washer 418 and the bearing member 422, so as to provide lubrication.

The bearing member 422 has a generally T-shaped cross-section. It Includes a first bearing surface 424 on a raised portion on the top of the T; and In use, this surface is disposed opposite a second bearing surface 426, of substantially the same annular shape and size, on the shaft 116 near the armature section 304. The bearing member 422 has a central cylindrical channel 428, thereby defining a cylindrical third bearing surface 430 on bearing member 422 that is disposed opposite fourth bearing surface 432 on the outside of shaft 116. A fifth bearing surface 434 is provided on the bearing member 422 on the end thereof opposite the first bearing surface 424, and this is disposed opposite a respective surface of the washer 418. In one embodiment, the working fluid permeates all the spaces defined opposite bearing surfaces 424, 430 and 434 of bearing member 422, thereby providing lubrication of the bearing. In one embodiment, the working fluid is provided as a liquid from the pump 144 (see FIG. 1(a)) via a fluid pipe 160, separate from the main flows, communicating with the outer surface of the bearing member 422.

It will be appreciated that the bearing in this form provides a bi-directional thrust bearing: the bearing member 422 has two bearing surfaces 424 and 434, enabling it to receive thrust in two directions.

FIG. 5 shows in more detail the bearing member 422 employed in the bearing in FIG. 4, indicating fluid flows. FIG. 5(a) is an end view showing the first bearing surface 424. The flange 502, forming the top of the T, is provided with two screw holes 504 enabling the bearing member 422 to be screwed or bolted to the housing 310 of the alternator 120. Six equally spaced radially extending first elongate recesses (slots) 506 are disposed in the first bearing surface 424, extending from radial inner extremity of the first bearing surface 424 towards the outer radial extremity of the firs bearing surface 424, enabling the passage of lubricant fluid. As can be seen in FIG. 5(b), each recess 506 does not quite reach the outer extremity 508 of the first bearing surface 424. In the embodiment of FIG. 5(a), each recess 506 is provided with an axially extending second lubrication channels 510, which extend to a circumferential recess (or groove) described hereinafter.

In other embodiments, there may not be a second lubrication channel 510 in each recess 506: for example, FIG. 5(c) illustrates the case where a second lubrication channel 510 is provided in only two of the recesses 506.

Referring to FIG. 5(d), a circumferentially extending recess (groove) 512 is provided in the outer surface 514 of bearing member 422. It can been seen that first lubrication channels 516 (here, four of them, equally circumferentially spaced) extend between the circumferentially extending recess 512 and the interior of the bearing member 422, allowing passage of lubrication fluid. As best seen in FIG. 5(e), the second lubrication channels 510 extend between the first bearing surface 424 and the circumferential recess 512. The ends of the second lubrication channels 510 are also shown in FIG. 5(f). The latter figure also shows a plurality (here six) of second elongate recesses (slots) 516 disposed in the fifth bearing surface 434. Two of the second elongate recesses 516 have second lubrication channels extending therefrom to the aforementioned circumferential recess 512. FIG. 5(g) is a partial cross-section showing the recesses and channels in another way.

Returning to FIG. 5(e), the lubrication fluid enters the bearing member 422 in the direction of arrows K. The fluid flows in the direction of arrows L to the first elongate recesses 506 on the first bearing surface 424, In the direction of arrow M to the second elongate recesses 516 on the fifth bearing surface 434, and in the direction of arrow N (into the paper) to the interior of the bearing member and the third bearing surface 430, thereby lubricating the bearing.

### EXAMPLE 1

The specific values for one example (6 kW version) of the system are set out below. All pressures are in bar (absolute). All temperatures are in ° C. The working fluid is HFE-7100.

| t1 | t2 | t3 | t4 | t5 | t6 | t7 |
|---|---|---|---|---|---|---|
| 180.0 | 123.4 | 111.0 | 165.0 | 130.0 | 65.0 | 55.0 |

| p1 | p2 | p3 |
|---|---|---|
| 11.5 | 1.0 | 3.4 |

### EXAMPLE 2

The specific values for a second example (120 kW version) of the system are set out below. All pressures are in bar (absolute). All temperatures are in ° C. The working fluid is hexane.

| t1 | t2 | t3 | t4 | t5 | t6 | t7 |
|---|---|---|---|---|---|---|
| 225.0 | 138.8 | 123.8 | 210.0 | 145.9 | 74.0 | 64.0 |

| p1 | p2 | p3 |
|---|---|---|
| 19.5 | 1.0 | — |

The results from the system demonstrate a very useful thermodynamic efficiency (usable electricity out to heat in) for the heat recovery and solar thermal industries—10% for a source fluid input at 110° C. to 22% for a source fluid input at 270° C.

Referring to FIG. 6, this illustrates an alternative (magnetic) coupling of the turbine unit and alternator of FIG. 1(a), in another aspect of the invention. The view in FIG. 6(a) is an axial cross-section of the coupling, showing a first rotary member 602 formed of turbine shaft 604 and a first magnetic member 606. In turn, the first magnetic member 606 comprises an armature portion 608, made of steel or iron, integral with the shaft, and a plurality of magnet sections 610, to be described further hereinbelow.

The first rotary member 602 is hermetically sealed inside a housing 612 that contains the turbine (not shown) and working fluid, the housing including a cylindrical portion 614 containing the first magnetic member 606. At least the portion 614 is made of a non-magnetic material, such as stainless steel, nimonic alloy or plastic.

A second rotary member 616 comprises a second shaft 618 and a generally cylindrical second magnetic member 620 integral therewith. The second magnetic member in turn comprises an outer supporting member 622 having a plurality of second magnet sections 624 fixedly attached to the interior thereof.

As best shown in FIG. 6(b), the first rotary member 602 may have a composite containment shell 626 around at least the cylindrical part thereof, so as to maintain the first magnet sections 610 in place during high-speed rotation. The containment shell may be made of a composite such as carbon fibre reinforced plastic (CFRP), kevlar, or glass fibre reinforced plastic (GRP).

FIG. 6(c) is a transverse cross-section at A-A in FIG. 6(a). This shows the first magnet sections 610 and second magnet sections 624 in more detail: in this case there are four of each. The magnet sections are elongate, with a cross-section similar to the sector of a disc. The magnet sections are permanent magnets formed of a suitable material, such as ferrite material, samarium cobalt or neodymium iron boron. The direction of the North-South direction for the magnet sections is radial, as schematically illustrated in FIG. 6(d).

Turning to FIG. 6(e), this shows an alternative embodiment, in which the first magnetic member 606′ and the second magnetic member 620′ are substantially disc-shaped. The first magnetic member 606′ comprises a first mounting section 628 and first magnet sections 610′, and the second magnetic member 620′ includes a second mounting section 630 and second magnet sections 624′. As before, a non-magnetic portion 614′ of the housing (similar to 614 and made of the aforementioned non-magnetic material) separates the faces of the disc-shaped magnetic members 606′ and 620′, which are in close proximity.

The arrangement of the poles for the magnet sections one or both of the first and second magnetic members 606′, 620′ is illustrated schematically in FIG. 6(f). As also illustrated in FIG. 6(g), the polarity of the face of the magnet sections 610′ (or 624′) alternates as you go tangentially from magnet section to magnet section.

These magnet arrangements permit coupling and transfer of rotational energy and torque from the turbine shaft 604 to the shaft 618 of the alternator, and are adapted to do so at relatively high speeds, e.g. 25,000 to 50,000 rpm.

FIG. 7 provides various views of a microturbine-based system (a) In isolation, (b) with a recuperator, and (c) and (d) the same systems as (a) and (b), respectively, incorporating, in accordance with aspects on the invention, an energy recovery system.

Referring to FIG. 7(a), this shows a microturbine system generally designated 700. Such systems are typically typically rated of the order of 60 kW and are used in medium to large buildings (residential, commercial, government, etc.) to generate electricity from the onsite combustion of fuel.

The microturbine system 700 includes a combustor 702 fed by a fuel supply line 704 and air supply line 706 providing oxygen-containing gas, e.g. air. The fuel supplied via line 704 may be, for example, natural gas, diesel, or kerosene. The exhaust hot gases from the combustor 702 are conveyed via exhaust conduit 708 to a turbine 710 where they impart rotational energy to the turbine shaft 712. The turbine shaft 712 drives both a generator 714 (e.g. including an alternator, as is well known in the art, thereby generating electrical energy) and a compressor 716. The compressor 716 takes air via inlet 718, compresses it and provides it at raised pressure via air supply line 706 to the combustor 702.

The exhaust outlet 720 of the turbine 710 typically releases still-hot gases into the atmosphere, thereby wasting heat; although some heat energy In the exhaust gases may be used for providing heat within the building at which the microturbine, at least some of the heat is lost in the release of hot gases. For example, In some systems, the electricity generated can be of the order 60 kW and the heat generated of the order 400 kW. The electrical efficiency of the system can be improved by adding a component.

FIG. 7(b) shows an alternative configuration of the microturbine system 700 of FIG. 7(a): here, a recuperator 722 is additionally employed, fed by the hot exhaust gases at the outlet 720 of the turbine 710. The recuperator 722 may be an off-the-shelf heat exchanger, but is suitably a heat exchanger custom-designed for the purpose. Here, the air supply line 706 is not connected to the combustor 702 but feeds the recuperator 722. Thus, in use, the recuperator 722 extracts heat from the exhaust gases of the turbine 710 and uses it to preheat the air that is passed via recuperated air supply line 724 to the combustor 702. The recuperator 722 nevertheless still release still-warm exhaust gases via recuperator outlet 726.

The effect of the recupertor on the system can be seen in the first two rows in Table 2.

TABLE 2

| | Electrical power output (kW) | | | Heat output | Electrical |
|---|---|---|---|---|---|
| System | Microturbine | ERS | Total | (to 100° C.) | efficiency |
| Microturbine | 60.0 | 0.0 | 60.0 | 200.0 | 16.0 |
| Recuperated | | | | | |
| microturbine | 60.0 | 0.0 | 60.0 | 100.0 | 26.0 |
| Microturbine | 60.0 | 32.5 | 92.5 | 13.5 | 24.7 |
| with ERS | | | | | |
| Recuperated | | | | | |
| microturbine | 60.0 | 14.5 | 74.5 | 13.0 | 34.8 |
| with ERS | | | | | |

The data in the second two rows will be discussed hereinafter. It will be seen that the heating of the air supply by the recuperator results in improved heat utilisation and therefore increased electrical efficiency (26% versus 16%) of the system in FIG. 7(b). However, a disadvantage is that a lot of energy is still embodied in the heat of the exhaust gases, and the electrical efficiency has not been optimised. Also, recuperators are expensive and unreliable, and if they fail during operation they stop the entire system running.

FIGS. 7(c) and (d) illustrate the same systems as (a) and (b), respectively, incorporating, in accordance with aspects on the invention, an energy recovery system (ERS), generally designated 100. The energy recovery system 100 is suitable the same as the system described hereinabove with reference to FIG. 1(a), and will therefore not be discussed further in detail.

In the arrangement of FIG. 7(c), the turbine exhaust 720 of the turbine 710 feeds via line 728 an intermediate heat exchanger 730, which in turn has an intermediate heat exchanger exhaust outlet 732 that, in use, releases exhaust gases at a lower temperature than at the turbine exhaust 720. In operation, heat transfer oil (e.g. BP Transcal N) circulates between the intermediate heat exchanger 730 and the main heat exchanger (or boiler) 102 of the energy recovery system 100 via lines 734 and 736. The heat in the heat transfer oil is transferred to the working fluid in the main heat exchanger, thereby providing the source of heat from which electrical energy Is derived as described above with reference to FIG. 1, etc.

In the arrangement of FIG. 7(d), it is the recuperator outlet 726 that feeds the intermediate heat exchanger 730, so that the amount of heat available to be transferred in the intermediate heat exchanger 730 is less than in the previously described arrangement. The operation is, however, the same.

Advantageous effects of this use of the intermediate heat exchanger 730 include the separation of the (Rankine cycle) energy recovery system from the potentially very high exhaust temperatures, enablement of better control of the system, and allowing operation of the microturbine 700 without (i.e. independent of) the energy recovery system 100.

Further benefits are apparent when considering a particular example (see the third and fourth rows of Table 2), in this case, a 60 kW microturbine.
1. The overall electrical efficiency of the system is substantially increased: In the system of FIG. 7(c) it is raised almost to the level of the recuperated system of FIG. 7(b). In the recuperated system (FIG. 7(d)), it is increased to almost 35%, high for a unit of this size.
2. The overall electrical output Is increased. The unrecuperated microturbine (FIG. 7(c)) now gives 92.5 kW, and the recuperated microturbine (FIG. 7(d)) gives 74.5 kW.

As indicated, unlike with the recuperator 722 in the system of FIG. 7(b), a further advantage of the use of the energy recovery system 100 is that if it fails or has to be shut down during operation, the microturbine system 700 is not affected and can go on running regardless of the state of the energy recovery system 100. The only drawback of the system is that the heat available in the exhaust (column 5 in Table 2) is now much lower: it is now dumped at around 50° C., too low to be of much use. However, the object is to extract more useful electricity.

FIG. 8 shows (a) an IC engine based energy generation system, and (b) the same system incorporating, in accordance with another aspect of the invention, an energy recovery system. Referring to FIG. 8(a), the energy generation system, generally designated 800, includes a reciprocating IC engine 802 having fuel supply line 804 and air supply line 806. Cooling of the IC engine 802 is facilitated by cooling water inlet 808 and outlet 810 to reduce the temperature of the engine during operation. The IC engine, using well-known techniques, provides drive via gears, couplings, etc. as appropriate, and shaft 812 to a generator 814, e.g. an alternator. In the system, as is well known, hot exhaust gases are despatched, during the exhaust stroke of the IC engine 802, via exhaust outlet 816: these hot gases feed an exhaust gas heat exchanger or boiler 818 used for combined heat and power applications.

Turning to FIG. 8(b), this shows the system of FIG. 8(a) Incorporating the energy recovery system 100 of FIG. 1(a). Here, the boiler 818 is replaced by the intermediate heat exchanger 730 (as in FIG. 7(c)), which transfers heat to the energy recovery system 100 by the heat transfer oil circuit provided by lines 734 and 736.

In the system of FIG. 8(b), the engine cooling water output from outlet 810 is also available for heat, an this is unaffected by the deployment of the energy recovery system 100 in this system. As with the systems of FIGS. 7(c) and (d), the presence of the energy recovery system 100 increases electrical power output and raises electrical efficiency. Table 3 illustrates the results for a typical 90 kW reciprocating natural gas engine.

TABLE 3

| | | | | Heat | | |
|---|---|---|---|---|---|---|
| | | | | output— | | |
| | | | | engine | Heat | |
| | Electrical power output (kW) | | | cooling | output— | Electrical |
| | Reciprocating | | | water (kW) | exhaust | efficiency |
| System | engine | ERS | Total | (90° C.) | gas (kW) | (%) |
| Reciprocating | 90 | 0.0 | 90.0 | 63.0 | 77.0 | 33.0 |
| engine | | | | | | |
| Reciprocating | 90.0 | 7.0 | 97.0 | 63.0 | 0.0 | 35.6 |
| engine with | | | | | | |
| ERS | | | | | | |

FIG. 9 shows a flare stack based energy generation system incorporating, in accordance with another aspect of the invention, an energy recovery system 100. Flare stacks are tower-like structures employed at landfill sites, oilfields, and other sites where there is an excess, or waste product, gas supply incorporating combustible gases.

At landfill sites, landfill gas builds up and must be disposed of, and often it is very polluting. The landfill gas is mainly methane with many impurities. The composition for one typical site is indicated in Table 4. However, other sites report getting over 50% methane; the type and quantity of the constituents vary considerably depending on the type of waste in the landfill.

TABLE 4

| Constituent | Volume |
|---|---|
| Ch₄ | 35% |
| N₂ | 20% |
| O₂ | 5% |
| CO₂ | 40% |
| H₂S | 232 ppmv |
| VOCs | 743 ppmv |

Returning to FIG. 9, as can be seen the flare stack 900 includes a base stage 902 into which air is blown via a blower 904. Immediately above the base section is a combustion stage 904 into which landfill gas is passed (including by pumping) via inlet 906. Above the combustion stage 904 is a mixer stage 908 in which the landfill gas is mixed with a supply of air that is entrained into the mixer stage 908 via air inlet 910.

As with the embodiments of FIGS. 7 and 8, an intermediate heat exchanger 730 is provided, this time as the upper stage of the stack 900. Again, using heat transfer oil circulating through lines 734 and 736, the intermediate heat exchanger 730 thus provides the source of heat for the main heat exchanger 102 of the energy recovery system 100 discussed above in relation to FIG. 1(a).

In flare stacks, the typical heat outputs are in the region of 5MW or so. Using the energy recovery system 100 via the intermediate heat transfer oil circuit, heat can be recovered from the exhaust of the stack. Electrical power generated by the energy recovery system 100 can be exported to the grid. Alternatively or additionally, the energy recovery system 100 is electrically coupled to the blower 904 to power it electrically. The effect of blowing increased air into the stack 900 (at the base stage 902) is to reduce emissions from the stack itself by lowering combustion temperatures; nitrogen oxide emissions can be reduced in this way. In addition, the increased time of dwell in the stack 900 due to the addition of the heat exchanger 730 gives more time for chemical reactions to occur, thereby also cutting harmful emissions from the stack.

Data suggests that the number of flare stacks in which these techniques may be employed is in the many hundreds in some countries and of the order of several thousand in others. It is also envisaged for a stack outputting a total of 1 MW, electrical energy of the order of 200-250 kW may be recovered by the use of the aforementioned systems. This is particularly useful as many stacks are in remote, rural areas (landfills, oilfields), and it is particularly desirable that as much electrical energy as possible is generated on site.

1. An energy recovery system, for extracting electrical energy from a source of heat, the system having a circulating working fluid, comprising:
a first heat exchanger for receiving source fluid, incorporating at least part of the heat of the source of heat and for receiving said working fluid, whereby heat is transferred from the source fluid to the working fluid;
an expansion unit, arranged to receive the working fluid output from the first heat exchanger whereby mechanical energy is imparted to the expansion unit;
an electromechanical conversion unit, coupled to the expansion unit, for converting said mechanical energy into electrical energy,
a cooling system, coupled to the expansion unit and to the first heat exchanger, for receiving the working fluid from the expansion unit, cooling the fluid, and supplying the fluid to the first heat exchanger.

2. The system of claim 1, wherein:
the system is a closed system with a circulating working fluid,
the first heat exchanger is adapted for receiving source fluid, incorporating the heat, at a first temperature and outputting said waste fluid at a second temperature, and for receiving said working fluid at a third temperature and outputting the working fluid at a fourth temperature, said fourth temperature being higher than said third temperature and higher than the boiling point of the working fluid;
the expansion unit comprises a turbine unit, arranged to receive the working fluid output from the first heat exchanger at a first pressure and to output the working fluid at a second pressure, said second pressure being lower than the first pressure, the turbine unit thereby imparting rotational energy to a turbine shaft mounted within the turbine unit; and
the electromechanical conversion unit is coupled to the turbine shaft, for converting said rotational energy into electrical energy.

3. The system of claim 2, wherein the cooling system includes a second heat exchanger, coupled to the turbine unit and to the first heat exchanger, for receiving a first supply of working fluid from the turbine unit at said fifth temperature and outputting working fluid from said first supply at a sixth temperature, said sixth temperature being lower than said fifth temperature;
wherein the second heat exchanger is further adapted to receive a second supply of working fluid in liquid form at a seventh temperature and output working fluid from the second supply of fluid to said first heat exchanger at said third temperature.

4. The system of claim 3, wherein the cooling system further includes a condensing unit, coupled to the second heat exchanger and adapted to receive a supply of cooling fluid, for receiving the working fluid output by the second heat exchanger at said sixth temperature and outputting working fluid in liquid form at said seventh temperature, said seventh temperature being lower than said sixth temperature and lower than the boiling point of the working fluid.

5. The system of claim 4, wherein the cooling system includes a pump, coupled to the cooling unit, for receiving the liquid working fluid at said seventh temperature and pumping said liquid working fluid to said second heat exchanger, thereby providing said second supply of working fluid to the second heat exchanger.

6. The system of any of claims 1 to 5, wherein said first temperature is about 110 to about 225° C.

7. The system of any of claims 1 to 6, wherein said second temperature is about 80 to about 140° C.

8. The system of any of claims 1 to 7, wherein said first temperature is about 180° C. and said second temperature is about 123° C.

9. The system of any of the preceding claims, wherein said first pressure is about 10 to 30 bar absolute.

10. The system of any of the preceding claims, wherein said second pressure is about 0.5 to 2 bar absolute.

11. The system of any of the preceding claims, wherein the turbine shaft is mounted on a bearing within said turbine unit, and said working fluid permeates said turbine unit, thereby providing lubrication of said bearing.

12. The system of any of the preceding claims, wherein the working fluid comprises a single component fluid selected from the alkanes.

13. The system of any of the preceding claims, wherein the working fluid comprises a fluid with a boiling point of about 30-110°.

14. The system of any of the preceding claims, wherein the electromechanical conversion unit includes an alternator adapted to output electric current.

15. The system of any of the preceding claims, wherein the electromechanical conversion unit includes an electrical conditioning unit, coupled to said alternator, for altering the frequency of the current received from the alternator and outputting current at mains frequency.

16. The system of any of the preceding claims, wherein the expansion unit comprises a turbine unit having a shaft and at least one turbine stage mounted thereon, the or each turbine stage incorporating a set of vanes.

17. The system claim 16, wherein the at least one turbine stage is made of aluminium or steel.

18. The system claim 16, wherein the at least one turbine stage is made of plastics material.

19. The system claim 18, wherein the plastics material is (a) polyetheretherketone (PEEK) containing carbon fibre, for example PEEK with 40% carbon fibre, (b) Ultern 2400, or (c) Valox 865.

20. An energy recovery system substantially as hereinbefore described with reference to the accompanying drawings.

21. The use of HFE-7100 or hexane or water as the working fluid and/or lubrication fluid in the energy conversion system of any of the preceding claims.

22. The use of one of the alkanes as the working fluid and/or lubrication fluid in the energy conversion system of any of the appended claims.

23. An electrical energy generation system, comprising:
a microturbine system, the microturbine system comprising
a combustion unit, coupled to a source of fuel, for combusting said fuel and outputting a first exhaust fluid,
a turbine, coupled for receiving said first exhaust fluid whereby rotational energy is imparted, in use, to a turbine shaft of the turbine, the turbine being adapted to a output second exhaust fluid,
an intermediate heat transfer unit, coupled for receiving said second exhaust fluid and adapted for performing a transfer of heat from the second exhaust fluid to an intermediate heat transfer fluid and to output the intermediate heat transfer fluid after said transfer of heat, and
an energy recovery system according to any of claims 1 to 20, the energy conversion system having said first heat exchanger coupled for receiving said intermediate heat transfer fluid, the intermediate heat transfer fluid embodying said source of heat.

24. The electrical energy generation system of claim 23, wherein the microturbine system further includes a compressor, coupled to the turbine and the combustion unit, and driven, in use, by the turbine shaft, the compressor receiving a supply of oxygen-containing fluid and supplying said oxygen-containing fluid in a compressed state, in use, to the combustion unit.

25. The electrical energy generation system of claim 23 or 24, wherein the microturbine system further includes a generator, coupled to the turbine and driven, in use, by the turbine shaft, the generator being adapted to output electrical energy.

26. The electrical energy generation system of any of claims 23 to 25, further including a recuperator, disposed between the turbine and the Intermediate heat transfer unit and coupled for receiving said second exhaust fluid and outputting third exhaust fluid to the intermediate heat transfer unit, the recuperator being further adapted for receiving a supply of oxygen-containing fluid, for example from the compressor, and for conveying said oxygen-containing fluid to the combustor after transfer of heat thereto from said second exhaust fluid.

27. The electrical energy generation system of claim 26, the recuperator comprises a heat exchanger.

28. An electrical energy generation system, comprising:
an internal combustion system, the internal combustion system comprising
an internal combustion engine, coupled to a source of fuel, for combusting said fuel and outputting an engine exhaust fluid, the internal combustion engine being arranged whereby rotational energy Is imparted, in use, to an drive shaft,
an intermediate heat transfer unit, coupled for receiving said engine exhaust fluid and adapted for performing a transfer of heat from the engine exhaust fluid to an intermediate heat transfer fluid and to output the intermediate heat transfer fluid after said transfer of heat, and
an energy recovery system according to any of claims 1 to 20, the energy conversion system having said first heat exchanger coupled for receiving said intermediate heat transfer fluid, the intermediate heat transfer fluid embodying said source of heat.

29. The electrical energy generation system of claim 28, wherein the internal combustion system further includes a generator, coupled to the internal combustion engine and driven, in use, by the drive shaft, the generator being adapted to output electrical energy.

30. The electrical energy generation system of claim 28 or 29, wherein the internal combustion engine is coupled to a supply of fuel and to a supply of oxygen-containing fluid.

31. An electrical energy generation system, comprising:
a waste gas disposal stack, the waste gas disposal stack including
a base stage, the base stage including a blower for blowing oxygen-containing gas into the waste gas disposal stack,
a combustion stage, adjacent the base stage, coupled to a source of waste gas, the waste gas being or including a combustible gas, the combustion stage being adapted to combust, in use, said waste gas in said oxygen-containing gas,
a mixer stage, adjacent said combustion stage, adapted to generate a mixture of gases comprising air mixed with the combustor exhaust gases resulting from said combustion stage,
an intermediate heat transfer unit, coupled for receiving said mixture of gases and adapted for performing a transfer of heat from the mixture of gases to an intermediate heat transfer fluid and to output the intermediate heat transfer fluid after said transfer of heat, and
an energy recovery system according to any of claims 1 to 20, the energy conversion system having said first heat exchanger coupled for receiving said intermediate heat transfer fluid, the intermediate heat transfer fluid embodying said source of heat.

32. The electrical energy generation system of claim 31, wherein the blower comprises an electrically-powered blower, the blower is electrically coupled to the electromechanical conversion unit, and at least part of the electrical energy generated, in use, by the energy conversion system powers the blower.

33. The electrical energy generation system of any of claims 23 to 32, wherein the intermediate heat transfer unit comprises a heat exchanger, and/or intermediate heat transfer fluid comprises heat transfer oil.

34. A radial inflow turbine unit, comprising:
a housing with an inlet port for receiving fluid at a first pressure;
a shaft mounted on a bearing within the housing and having an axis of rotation;
a turbine, disposed on the shaft, the turbine comprising
a first turbine stage, comprising a first series of vanes mounted on the shaft, said fluid received by the inlet port being radially incident on said first series of vanes and exiting the first turbine stage at a third pressure and in a first predetermined direction,
a second turbine stage, comprising a second series of vanes mounted on the shaft,
a conduit for conveying the fluid exiting the first turbine stage to the second turbine stage,
said fluid received by the second turbine stage being radially incident on said second series of vanes and exiting the second turbine stage at a second pressure and in a second predetermined direction,
wherein said fluid imparts rotational energy to said shaft at both said first and second turbine stages.

35. The turbine unit of claim 34, wherein the first pressure is higher than the third pressure, and the third pressure is higher than the second pressure.

36. The turbine unit of claim 34 or 35, wherein the first pressure is about 2 to 10 times the second pressure.

37. The turbine unit of any of claims 34 to 35, wherein the third pressure is about 3-4 times the second pressure.

38. The turbine unit of any of claims 34 to 37, wherein the radial dimension of said second turbine stage is greater than the radial dimension of the first turbine stage.

39. The turbine unit of claim 38, wherein the radial dimension of second turbine stage is about 1.25 times the radial dimension of the first turbine stage.

40. The turbine unit of any of claims 34 to 39, wherein the axial dimension of said first turbine stage is about 0.3 to 0.375 times the radial dimension of the first turbine stage.

41. The turbine unit of any of claims 34 to 40, wherein the axial dimension of said second turbine stage is about 0.35 to 0.4 times the radial dimension of the second turbine stage.

42. The turbine unit of any of claims 34 to 41, further including:
a third turbine stage, comprising a third series of vanes mounted on the shaft,
a conduit for conveying the fluid exiting the second turbine stage to the third turbine stage,
said fluid received by the third turbine stage being radially incident on said third series of vanes and exiting the third turbine stage at a fourth pressure and in a third predetermined direction,
wherein said fluid imparts rotational energy to said shaft at said first, second and third turbine stages.

43. The turbine unit of claim 42, wherein the axial dimension of said third turbine stage is about ⅓ times the radial dimension of the third turbine stage.

44. The turbine unit of any of claims 34 to 43, wherein said first, second and/or third predetermined directions is generally axial.

45. The turbine unit of any of claims 34 to 44, wherein said fluid is a gas.

46. The turbine unit of any of claims 34 to 45, wherein said fluid is HFE-7100 or hexane or water.

47. The turbine unit of any of claims 34 to 45, wherein said fluid is one of the alkanes.

48. The turbine unit of any of claims 34 to 47, wherein said fluid permeates the housing, thereby providing lubrication of the bearing.

49. The turbine unit substantially as hereinbefore described with reference to the accompanying drawings.

50. A waste energy recovery system, for extracting energy from a source of waste heat, the system being a closed system with a circulating working fluid, comprising a heat exchanger, an electromechanical conversion unit, a cooling system and a turbine unit according to any of claims 34 to 49, the heat exchanger supplying, in use, the working fluid to said turbine unit.

51. A bearing for supporting a shaft rotatable about an axis and at least partially disposed within a housing, comprising:
a bearing member, fixedly attached to the housing and having a first bearing surface, opposite a second bearing surface on the shaft, said first and second bearing surfaces extending generally transverse to the axis, and a cylindrical internal channel defining a third bearing surface extending generally parallel to the axis and disposed opposite a fourth bearing surface on the shaft,
the bearing member including conduits adapted to convey lubricating fluid into at least the space third and fourth bearing surfaces.

52. The bearing of claim 51, wherein the bearing member has a generally T-shaped cross-section.

53. The bearing of claim 51 or 52, wherein the bearing member has, on the end thereof opposite the first bearing surface, a fifth bearing surface extending generally transverse to the axis.

54. The bearing of claim 52, wherein the first surface on the bearing element is defined by a raised annular surface on the top of the ‘T’ extending partially between the inner radial limit and the outer radial limit of the bearing member.

55. The bearing of claim 53, wherein a plurality of elongate first recesses are provided extending radially in the first surface, thereby facilitating flow of lubricant fluid to the space opposite the first surface.

56. The bearing of claim 55, wherein the first recesses extend partially between the inner radial limit and the outer radial limit of the first surface.

57. The bearing of any of claims 53 to 56, wherein a plurality of elongate second recesses are provided extending radially in the fifth surface, thereby facilitating flow of lubricant fluid to the space opposite the fourth surface.

58. The bearing of claim 57, wherein the second recesses extend partially between the inner radial limit and the outer radial limit of the fifth surface.

59. The bearing of any of claims 52 to 58, wherein at a point between the opposite ends of the elongate part of the ‘T’-shaped bearing member, a circumferential recess is defined in the surface at the outer radial limit of the bearing member.

60. The bearing of claim 59, wherein a plurality of first lubrication channels are provided, extending radially between the circumferential recess and the inner radial limit of the bearing member, thereby permitting flow of lubricant fluid between the exterior of the bearing member and the internal cylindrical channel.

61. The bearing of any of the claims 58 to 60, wherein the bearing member includes a plurality of second lubrication channels, each channel extending axially between a first elongate recess on the first surface and a respective opposite second elongate recess on the fifth surface.

62. The bearing of any of claims 51 to 61, wherein the number of first and/or second elongate recesses is between 2 and 8, and preferably 6.

63. The bearing of any of claims 51 to 62, wherein the number of second lubrication channels is between 2 and 8.

64. The bearing of any of claims 51 to 63, further including a washer, wherein, in use, one surface of the washer abuts the fifth surface of the bearing member and the other surface of the washer is adapted to abut a corresponding surface of a drive element, for example a turbine.

65. The bearing substantially as hereinbefore described with reference to the accompanying drawings.

66. A energy recovery system, for extracting energy from a source of waste heat, the system being a closed system with a circulating working fluid, comprising a heat exchanger, an electromechanical conversion unit, a cooling system and a turbine unit, the heat exchanger supplying, in use, the working fluid to said turbine unit as a gas, wherein the turbine unit is mechanically coupled to the electromechanical conversion unit via a shaft, the shaft being supported by a bearing according to any of claims 51 to 65.

67. The system of claim 66, further including a secondary working fluid supply line from the cooling system to the bearing whereby working fluid is supplied to the exterior of the bearing member, thereby providing the lubricant fluid for said bearing.

68. The system of claim 67, wherein the working fluid is supplied to the bearing as a liquid.

69. A rotary magnetic coupling, comprising:
a first rotary member, including a first shaft having disposed thereon a first magnetic member, said first shaft, in use, being driven by a source of rotational energy,
a second rotary member, including a second shaft having disposed thereon a second magnetic member, said second rotary member, in use, receiving rotational energy from the first rotary member through coupling of the first and second magnet members,
wherein one of said first and second magnetic members, or both, comprise a plurality of magnet sections disposed at different angular positions with respect to the axis of said first and second shafts.

70. The magnetic coupling of claim 69, wherein the first rotary member Is disposed within a hermetically sealed housing, a portion of the housing being disposed between the first rotary member and the second rotary member and being made of a non-magnetic material.

71. The magnetic coupling of claim 70, wherein the non-magnetic material comprises stainless steel, nimonic alloy, or plastic.

72. The magnetic coupling of claim 69 or 70, wherein the first magnetic member comprises an inner generally cylindrical armature portion integral with the first shaft and a plurality of first magnet sections fixedly attached on the exterior of the armature portion.

73. The magnetic coupling of any of claims 69 to 72, wherein the second magnetic member comprises an outer generally cylindrical supporting portion integral with the second shaft and a plurality of second magnetic sections fixedly attached to the interior of the supporting portion.

74. The magnetic coupling of any of claims 69 to 73, wherein the first magnetic member further comprises a containment shell, disposed on the exterior of the first magnet sections, for retaining said first magnet sections in position during high-speed rotation of the first shaft.

75. The magnetic coupling of any of claims 73 to 74, wherein the containment shell is made of a composite material, for example CFRF, Kevlar or GRP.

76. The magnetic coupling of any of claims 70 to 75, wherein the first magnetic member is disposed inside the second magnetic member and separated therefrom by the portion of the housing.

77. The magnetic coupling of any of claims 69 to 76, wherein the magnet sections comprise dipole magnets the N-S direction of each extending radially.

78. The magnetic coupling of any of claims 69 to 72, wherein the first magnetic member is generally disc-shaped and comprises a first mounting section having fixedly mounted within it the plurality of first magnet sections, the first magnet sections thereby forming a disc shape.

79. The magnetic coupling of claim 78, wherein the second magnetic member is generally disc-shaped and comprises a second mounting section having fixedly mounted within it the plurality of second magnet sections, the second magnet sections thereby forming a disc shape.

80. The magnetic coupling of any of claims 69 to 79, wherein the first and second magnet sections form sectors of a disc.

81. The magnetic coupling of any of claims 78 to 80, wherein the first and second magnet sections comprise dipole magnets with the N-S direction of each extending axially.

82. The magnetic coupling of any of claims 78 to 81, wherein said first disc-shaped magnetic member is disposed axially aligned adjacent the second disc-shaped magnetic member and separated therefrom by the portion of the housing.

83. The magnetic coupling of any of claims 69 to 82, wherein the number of magnetic sections of said first magnetic member, and/or said second magnetic member, is an even number of 2 or more.

84. The magnetic coupling of any of claims 69 to 83, wherein the number of magnetic sections of said first magnetic member, and/or said second magnetic member, is 4.

85. The magnetic coupling of any of claims 69 to 84, wherein the said magnet sections are made of ferrite material, samarium cobalt or neodymium iron boron.

86. The magnetic coupling substantially as hereinbefore described with reference to the accompanying drawings.

87. A waste energy recovery system, for extracting energy from a source of waste heat, the system being a closed system with a circulating working fluid, comprising a heat exchanger, an electromechanical conversion unit, a cooling system and a turbine unit, the turbine being hermetically sealed and being coupled to the electromechanical conversion unit by a magnetic coupling according to any of claims 69 to 86.

88. A method carried out in a an energy recovery system for extracting energy from a source of waste heat, the system being a closed system with a circulating working fluid, comprising a heat exchanger, an electromechanical conversion unit including an alternator, a cooling system, a turbine unit, and a control system coupled to the electromechanical conversion unit and adapted to vary the voltage derived from the alternator, comprising the steps of
(a) increasing the voltage by one voltage step;
(b) measuring the output power of the alternator;
(c) if the output power measured in step (b) is less than or equal to the previous output power,
(i) decreasing the voltage by one voltage step
(ii) repeating the steps of
(1) decreasing the voltage by one voltage step
(2) measuring the output power of the alternator;
while the output power measured in step (c)(ii)(2) is more than the previously measured output power, and
if the output power measured in step (b) is more than the previous output power, repeating the steps of
(iii) increasing the voltage by one voltage step
(iv) measuring the output power of the alternator
while the output power measured in step (c)(iv) is more than the previously measured output power.

89. The method of claim 88, wherein each step of increasing the voltage by one voltage step is replaced by the step of decreasing the voltage by one voltage step, and vice versa.

90. The method of claim 88 or 89, wherein the voltage step is about 1% to 2.5% of the mean voltage.

91. The method of claim 88, 89 or 90, wherein step (a) is performed about every second.

92. The method of any of claims 88 to 91, wherein the step of measuring the output power of the alternator comprises measuring an output voltage V derived from the output of the alternator, measuring the output current I derived from the output of the alternator, and computing output power=V*I.

93. The method of any of claims 88 to 91, wherein the step of measuring the output power of the alternator comprises measuring the output power with a separate power-measuring device.

94. The method of any of claims 88 to 93, further comprising converting the alternator voltage from a first frequency to a second frequency.

95. The method of claim 94, wherein the first frequency is higher than the second frequency, and the second frequency is about the frequency of the mains supply.

96. The method of claim 94 or 95, wherein said step of converting the voltage comprises:
rectifying the voltage output by the alternator using a rectification circuit thereby deriving a dc voltage, and
generating an ac voltage from said do voltage using a power-conditioning unit

97. The method of any of claims 88 to 96 further comprising storing the last-measured value of the output power.

98. The method of controlling an energy recovery system substantially as hereinbefore described with reference to the accompanying drawings.

99. A programmable control system when suitably programmed for carrying out the method of any of claims 88 to 98, the system including a processor, a memory, an interface coupled to the electromechanical conversion unit, and a user interface.

100. The control system of claim 99, including a frequency conversion device for altering the frequency of an a.c. voltage.

101. A working fluid purification system for an energy conversion system, the energy conversion system being a closed system with a circulating working fluid circulating in a path therethrough and including an expansion device, for example a turbine, comprising:
an expansion tank;
a diaphragm within the expansion tank, thereby defining a variable volume connected for receiving said working fluid; and
a control valve disposed between said path and the expansion tank, the control valve being adapted to control the flow of fluid to and/or from said variable volume;
wherein the control valve is connected via a conduit to a connection point in the path, said connection point being at the highest point of said path.

102. The system of claim 101, wherein the control valve is mounted at a higher point than said connection point.

103. The system of claim 101 or 102, wherein the expansion tank is mounted at a higher point than said control valve.

104. The system of any of the preceding claims, further including a controller, the controller being adapted to open and close said control valve.

105. The system of claim 104, wherein the controller is configured to perform a purification cycle, said purification cycle comprising opening the control valve for a first predetermined period and closing the control valve for a second predetermined period.

106. The system of claim 105, wherein the controller is configured to perform, in a startup sequence of predetermined duration after switch-on of the system, a plurality of said purification cycles.

107. The system of claim 106, wherein said plurality of purification cycles comprises about 3 to 5 purification cycles.

108. The system of claims 105 to 107, wherein the first predetermined period is about 1 minute and said second predetermined period is about ten minutes.

109. The system of any of claims 101 to 108, further including a pressure sensor coupled to the controller; wherein the controller is configured to perform at least one purification cycle when the pressure indicated by the sensor is above a predetermined level.

110. A working fluid purification system substantially as hereinbefore described with reference to the accompanying drawings.

111. An energy recovery system for extracting electrical energy from a source of heat, comprising: the working fluid purification system of any of claims 101 to 110, a turbine, a heat exchanger, an electromechanical conversion unit, and a cooling system, the heat exchanger supplying, in use, the working fluid to said turbine.
